(19) United States
(12) Patent Application Publication
(10) Pub. No.: US 2019/0168406 A1
(43) Pub. Date: Jun. 6, 2019

(54) AUTOMATED WORK PIECE POSITIONING AND MEASUREMENT DATA PROCESSING TOOLS

(71) Applicant: VELOCITY ROBOTICS, INC., Pittsburgh, PA (US)

(72) Inventors: Bradley S. Kriel, Pittsburgh, PA (US); Mikhail Novikov, Oakmont, PA (US); Kartik Babu, Pittsburgh, PA (US); Erin Hsi, Pittsburgh, PA (US); Barry M. Stoots, Verona, PA (US); Jason Kriek, Cranberry Township, PA (US)

(21) Appl. No.: 16/268,103

(22) Filed: Feb. 5, 2019

Related U.S. Application Data
(63) Continuation-in-part of application No. PCT/US2017/045767, filed on Aug. 7, 2017.
(60) Provisional application No. 62/371,450, filed on Aug. 5, 2016.
(60) Provisional application No. 62/394,257, filed on Sep. 14, 2016.

(51) Int. Cl. B27B 27/10; B23D 59/00; B27B 5/29; G05B 19/402

(52) U.S. Cl. CPC B27B 27/10; B23D 59/001; G05B 2219/23161; G05B 19/402; B23D 59/008; B27B 5/29

(57) ABSTRACT

A work piece positioning system structured for use with work piece processing equipment. The positioning system comprises a guide rail assembly having at least one guide rail, a measurement pattern positioned on at least a portion of at least one guide rail; and a carriage assembly structured for slidable engagement with at least a portion of the guide rail of the guide rail assembly. The carriage assembly may include a controller configured for wireless data communication with at least one mobile computing device, and a stop block. In different embodiments, the controller can be programmed to receive data communicated from an electronic measurement device; to receive a cut-list including a list of cuts to be made on the work piece processing equipment; and/or to receive data derived from at least one information source associated with at least one dimension of a work piece or at least one attribute of a work piece environment.

### CROSS-REFERENCE TO RELATED APPLICATIONS/PRIORITY CLAIM

The present application is a continuation-in-part of International Patent Application No. PCT/US2017/045767, filed Aug. 7, 2017, which claims the benefit of both U.S. Provisional Patent Application No. 62/371,450, filed on Aug. 5, 2016, and U.S. Provisional Patent Application No. 62/394,257, filed on Sep. 14, 2016.

### BACKGROUND

When preparing to cut a work piece on a miter saw or table saw, an operator typically measures and marks the work piece, lines up the mark with the work piece placed near the saw blade, and then starts the saw to begin cutting. In this overall process, the cutting step is the one that is the most permanent because it cannot be easily undone if performed incorrectly. A mistake in any of the steps prior to the cutting step usually results in an incorrect cut and/or wasted materials. However, many currently available products that could assist with reducing errors in the cutting process are too expensive for many users, do not leverage wireless communication technology, or do not take full advantage of collecting data from a pre-existing list of materials to be cut (i.e., a cut-list).

Accordingly, enhanced systems, tools, and techniques are needed which can reduce or eliminate operator reliance on the initial steps in the measuring, placement, and cutting process, especially in cases where a predetermined cut-list, specification, or design plan is available. Technology is needed that can leverage wireless data communication (e.g., Bluetooth technology or a similar wireless communication protocol) to relay work piece data and processing information between or among an electronic or non-electronic measurement device (e.g., tape measure), a mobile computing device, and/or one or more wireless-enabled components of work piece processing equipment (e.g., table saw). There is also a need to provide an automated work piece positioning mechanism at an economical cost but without sacrificing adequate precision. In addition, a modular system is needed that is flexible enough to process different kinds of materials, different material dimensions, or other operational parameters which vary as a function of a given work piece, project, or type of equipment.

### SUMMARY

In various embodiments, enhanced systems, tools, and techniques are provided for automatically preparing and wirelessly communicating with various types of work piece processing equipment for performing different operations on a variety of work pieces.

In one embodiment, a work piece positioning system is provided which comprises a guide rail assembly and a carriage assembly. The guide rail assembly is structured for connection to an item of work piece processing equipment and includes one or more guide rails and a measurement pattern positioned on at least a portion of at least one guide rail. The carriage assembly is structured for slidable engagement with at least a portion of the guide rail of the guide rail assembly. The carriage assembly may include a controller configured for wireless data communication with at least one mobile computing device and a stop block. programmed to receive data communicated from an electronic measurement device. In various embodiments, the controller may be programmed to receive a cut-list including a list of cuts to be made on the work piece processing equipment; to receive data derived from at least one information source associated with at least one dimension of a work piece or at least one attribute of a work piece environment; and/or to receive data associated with captured image data

In certain embodiments, a braking and positioning mechanism of the system may be configured for positioning the stop block in connection with a cutting operation to be performed on a work piece on the item of work piece processing equipment. The braking and positioning mechanism may comprise a coarse-adjust mechanism and a fine-positioning mechanism, wherein the coarse-adjustment mechanism is configured to move the carriage assembly along the guide rail assembly to position the stop block within a predetermined reach of the fine-positioning mechanism. The fine -positioning mechanism can be configured to move the stop block to a predetermined position on the guide rail assembly. In certain embodiments, the coarse-adjustment mechanism can be configured to permit manually sliding the carriage assembly to within a predetermined reach of the fine-positioning mechanism.

In various embodiments, a detection system may be configured to interact with the measurement pattern positioned on the guide rail assembly and to assist with positioning the stop block in a predetermined position on the guide rail assembly. In certain embodiments, the measurement pattern comprises an optical measurement pattern; the detection system comprises an optical detection system; and, the controller is programmed to determine the position of the stop block in response to the interaction of the optical detection system and the optical measurement pattern. In other embodiments, the measurement pattern comprises a metal-shaped pattern; the detection system comprises an inductive sensing detection system having a sensor board programmed to detect an amount of metal in the metal-shaped pattern; and, the controller is programmed to determine the position of the stop block in response to interaction of the detection system and the measurement pattern.

In certain embodiments, the carriage assembly may comprise at least one automatic brake structured to engage the stop block on the guide rail assembly until a desired operation is performed by the work piece processing equipment. The controller may be further programmed to receive data associated with at least one dimension or attribute of a work piece to be processed by the work piece processing equipment and to adjust actuation or movement of the carriage assembly in response to the received data. In certain embodiments, the work piece processing equipment comprises a controller programmed for wireless communication with the controller of the carriage assembly, the mobile computing device, and at least one electronic measuring device. In other embodiments, at least one of the controller of the work piece processing equipment or the controller of the carriage assembly can be programmed for resisting actuation of the work piece processing equipment when an error condition is detected.

In various embodiments of the invention, a work piece positioning system comprises: a guide rail assembly having a series of guide rail segments modularly connectable together within the guide rail assembly, wherein at least one of the connectable guide rail segments has a measurement pattern positioned on a portion thereof; and a carriage assembly structured for slidable engagement with at least a portion of the guide rail of the guide rail assembly. The carriage assembly may include a controller configured for wireless data communication with at least one mobile computing device, and a stop block. In certain embodiments, the series of guide rail segments may be foldable to a length less than an overall length of the series of guide segments when extended. In other embodiments, at least one of the series of guide rail segments is detachable or attachable to at least one of the other guide rail segments. In various embodiments, work stands of different types and configurations can be structured for mounting at least a portion of the guide rail assembly thereon.

In various embodiments, a work piece positioning system can be provided which comprises a guide rail assembly having at least one guide rail, a measurement pattern positioned on at least a portion of at least one guide rail; and a carriage assembly structured for slidable engagement with at least a portion of the guide rail of the guide rail assembly. The carriage assembly may include a controller configured for wireless data communication with at least one mobile computing device, and a stop block. In different embodiments, the controller can be programmed to receive data communicated from an electronic measurement device; to receive a cut-list including a list of cuts to be made on the work piece processing equipment; to receive data derived from at least one information source associated with at least one dimension of a work piece or at least one attribute of a work piece environment; and/or to receive data associated with captured image data.

In certain embodiments, the carriage assembly may comprise at least one automatic brake structured to engage the stop block on the guide rail assembly until a desired operation is performed by the work piece processing equipment. The controller may be further programmed to receive data associated with at least one dimension or attribute of a work piece to be processed by the work piece processing equipment and to adjust actuation or movement of the carriage assembly in response to the received data. In certain embodiments, the work piece processing equipment comprises a controller programmed for wireless communication with the controller of the carriage assembly, the mobile computing device, and at least one electronic measuring device. Also, at least one of the controller of the work piece processing equipment or the controller of the carriage assembly may be programmed for resisting actuation of the work piece processing equipment when an error condition is detected.

### BRIEF DESCRIPTION OF THE FIGURES

FIG. 1 schematically illustrates one example of an automated work piece processing system structured in accordance with certain embodiments of the invention.

FIG. 1B schematically illustrates an example of a tool-centric configuration for use in connection with an automated work piece processing system structured in accordance with certain embodiments of the invention.

FIGS. 2 and 3 illustrate examples of a work piece processing application configured to receive data from electronic measurement devices and to communicate with a controller of a carriage assembly.

FIG. 4 depicts an example of an operator using a measurement device to measure the length of a piece of wood.

FIG. 5 schematically illustrates an example of communication occurring between a measurement device and the processing application

FIG. 6 includes an example of a computing device programmed with the processing application.

FIGS. 7 and 8 show an example of a cut-list which can be displayed by the processing application.

FIGS. 9 and 10 reflect an example of a before and after situation involving a given item on a cut-list.

FIG. 11 includes another example of a computing device programmed with the processing application.

FIG. 12 illustrates an example of a computing device showing different kinds of cuts and materials which can be processed by the processing application.

FIGS. 13 and 14 illustrate examples of setting an offset for different dimensions to be processed through the processing application.

FIG. 15 includes an example of saving or storing a cut-list to be communicated to the work piece processing equipment from the processing application on the computing device.

FIGS. 16 and 17 illustrate examples of managing a stock list with the processing application.

FIGS. 18 through 25 illustrate examples of a sketch tool that can be provided through the processing application on the computing device.

FIGS. 26 through 29 provide examples illustrating operation of certain embodiments of the invention in connection with a work piece processing apparatus.

FIGS. 30 through 36 provide examples of certain aspects of the operation of a braking and positioning mechanism of a carriage assembly structured in accordance with certain embodiments of the invention.

FIG. 37 includes an example of an optical measurement pattern that can be used in connection with certain guide rail assembly and stop block embodiments described herein.

FIG. 38 illustrates examples of certain modular aspects of certain embodiments of the present invention.

FIG. 39 illustrates an example of employing multiple carriage assemblies structured for cooperative arrangement.

FIGS. 40 and 41 illustrate an example of an adapter sleeve which may be employed in connection with different kinds of measurement devices.

FIG. 42 illustrates an example of a user cutting a work piece using one embodiment of the invention attached to a miter saw.

FIG. 43 illustrates one example of an implementation of a carriage assembly sitting inside a guide rail assembly.

FIGS. 44 through 47 illustrate various aspects of a carriage assembly installed for use in association with a miter saw.

FIG. 48 illustrates various aspects of an example of a carriage assembly installed for use in association with a table saw.

FIG. 49 illustrates various aspects of an example of a carriage assembly installed for use in association with a drill press.

FIGS. 50A and 50B illustrate examples of the modularity aspects of a work piece positioning system.

FIGS. 51A-51C depict certain aspects of an example of a braking system for a braking and positioning system.

FIGS. 52A-52E show different aspects of an example of an inductive sensing detection system installed for use on a carriage assembly.

### DESCRIPTION

In various embodiments, the present invention may be embodied as a system of components, including both hardware and software, and a set of methods and processes employed by a user to cut work pieces with processing equipment (e.g., table saw or miter saw) to a desired size within a determined precision and accuracy. As applied at times herein, the term “AutoSet” may refer to the whole system and/or different components or processes associated with the system, such as components that are mechanically fixed to a cutting device or saw.

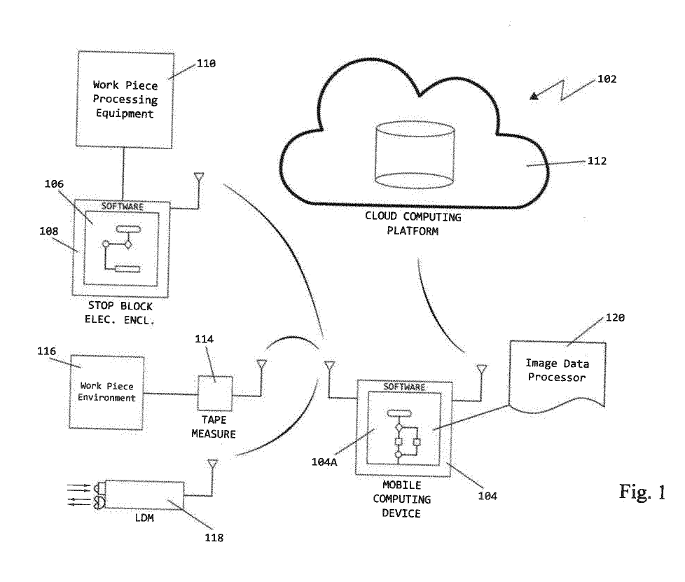

FIG. 1 provides an overview of one example of an automated work piece processing system 102 structured in accordance with certain embodiments of the invention. In this example, the system 102 includes a mobile computing device 104 configured for wireless data communication with a controller 106 comprising firmware, software or other computer -executable instructions and operatively associated with a carriage assembly 108. The mobile computing device 104 may be a smartphone, a tablet computer, a laptop computer, a desktop computer, or any other form of computing device with wireless radio transmission capability. The mobile computing device 104 may be configured for connection to the Internet or other networked media. In various embodiments, the carriage assembly 108 may include braking and positioning mechanisms for positioning a stop block in connection with a cutting operation, for example, performed on a type of work piece processing equipment 110 (e.g., table saw or miter saw). The carriage assembly 108 may be structured to slide along or within a guide rail assembly connected to the work processing equipment 110. The carriage assembly 108 may comprise a fine adjustment positioning mechanism, a position measurement assembly, a brake assembly, an electronics enclosure, and optionally a coarse drive mechanism. The controller 106 may be programmed or configured to receive measurements from the device 104, compute positions with its interface to the position measurement device and control the brake and motor via a motor control interface. Instructions stored on the controller 106 may also manage calibration functions and wireless connectivity with the computing device 104.

Wireless data communication may be facilitated by connection through a cloud computing platform 112, for example, or another suitable data communication medium. In operation, the mobile computing device 104 may be programmed with a work piece processing application 104A (e.g., software application) configured to receive and process data communicated from an electronic measurement device (e.g., tape measure 114 or laser distance meter 118) used to measure one or more physical dimensions or other attributes of a work piece environment 116. Such dimensions may include aspects of a work piece itself (e.g., length or width of stock material) and/or aspects of the environment 116 (e.g., a distance between a door and a wall of a house) in which the work piece will be employed. The measurement device may comprise a linear or volumetric distance measuring device with a wireless radio transmitter; including, for example, tape measures, laser distance meters, two-dimensional or three -dimensional LiDAR devices, stereo or monocular computer vision-based measuring devices or methods, or ultrasonic distance meters, among others. In certain embodiments, the mobile computing device 106 may be programmed to communicate with one or more other types of data storage media or data modules to store or retrieve work piece related data, for example, or other data.

In operation, the processing application 104A can be configured to create a cut -list of materials to be processed in connection with the work piece environment 116 data collected by the measurement device 114. The mobile computing device 104 may also receive or derive data from a design, plan, schematic, specification, or other document or information source associated with dimensions or attributes of one or more work pieces to be processed by the processing equipment 110. In certain embodiments, the computing device 104 may be in communication with the controller 106 to relay information that can be used to control actuation and movement of the carriage assembly 108 during operation of the work piece processing equipment 110 (as described herein).

In certain embodiments, the processing application 104A may include or be operatively associated with one or more image data processors 120. The image data processors 120 may include software, hardware, firmware, and/or a combination of components programmed to receive and process captured image data. The captured image data may be derived from the optics or other sensor of a camera, for example, such as a camera typically installed on different kinds of mobile devices 104. In one embodiment, the captured image data may include an image of a measurement portion of a non-electronic tape measure, for example, or other visual representations of measurement data obtained from the work piece processing environment 116. Processing the captured image data may include deriving a numerical value or other quantity which can be used by the processing application 104A, for example, in performing its various tasks and functions.

FIG. 1B schematically illustrates an example of a tool-centric approach to implementation of various automated work piece processing systems structured in accordance with certain embodiments of the invention. In this example, work piece processing equipment 132 includes a controller 132A comprising firmware, software or other computer-executable instructions programmed for directing functions or tasks performed by the work piece processing equipment 132, such as drilling a hole into a work piece, for example, or communicating other data. The electronic measurement device 114 and/or the mobile computing device 104 may be configured to receive or transmit data to the controller 132A of the work piece processing equipment 132. Likewise, one or more components of the carriage assembly 108 may be programmed for wireless communication with the controller 132A of the work piece processing equipment 132. For example, dimensions or other characteristics associated with a process to be performed on a work piece (e.g., a cut length) can be communicated from one or more of the carriage assembly 108, the mobile computing device 104, or the electronic measurement device 114 to the controller 132A, or among each other. In certain embodiments, one or more of these components 104, 108, 114, 132A may be programmed to communication instructions which resist actuation of the work piece processing equipment 132 when an error condition is detected. If the carriage assembly 108 detects and determines that a piece of wood is about to be cut at an improper angle by a saw 132 (this represents a detected error condition), for example, then the controller 132A of the saw 132 can be directed not to cut the piece of wood.

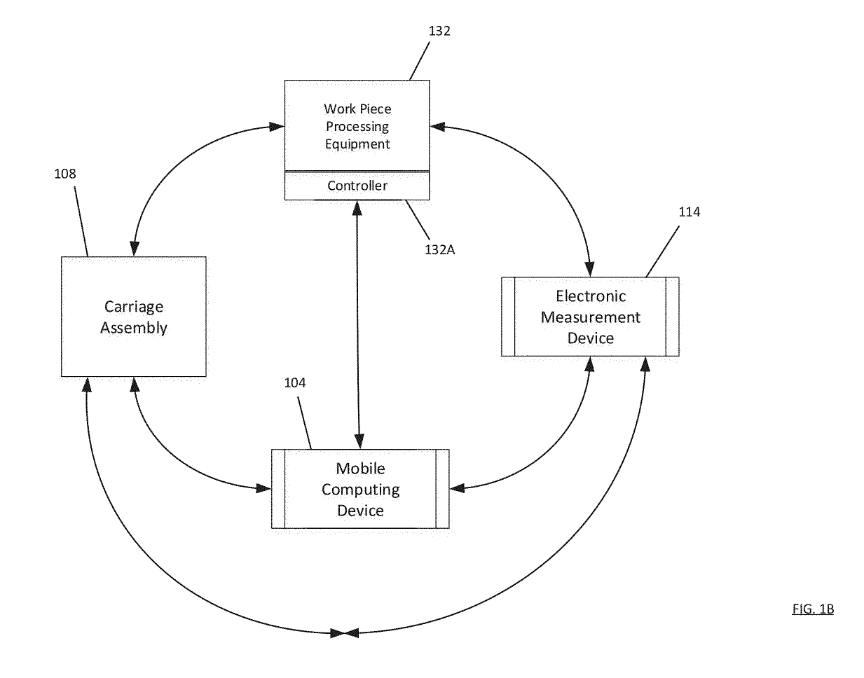

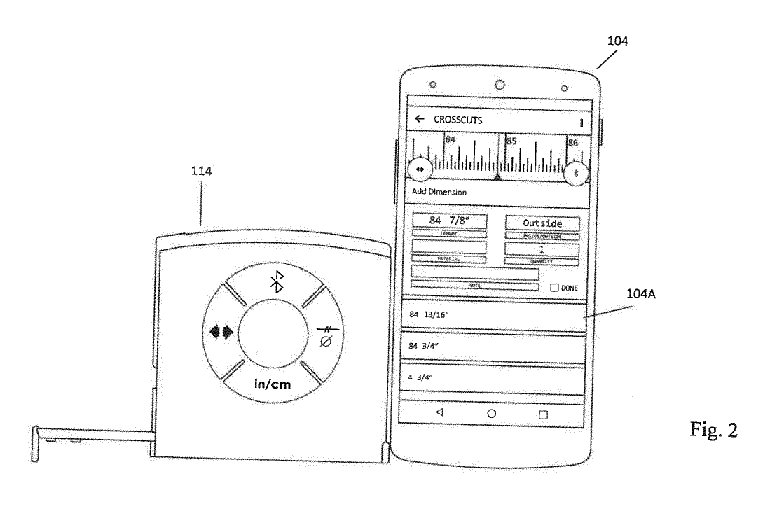

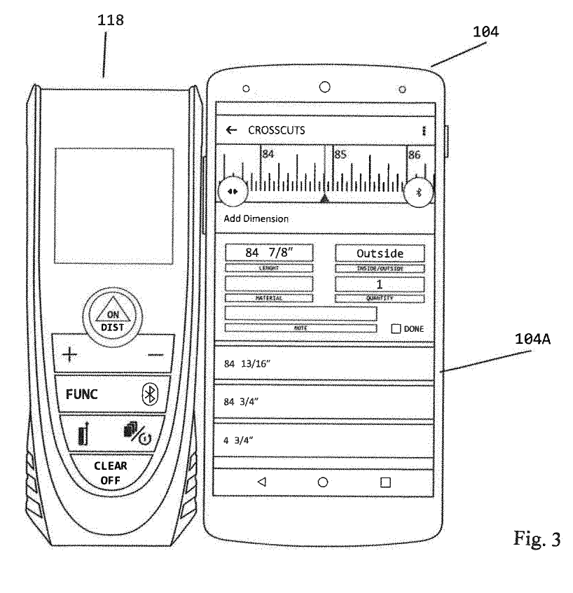

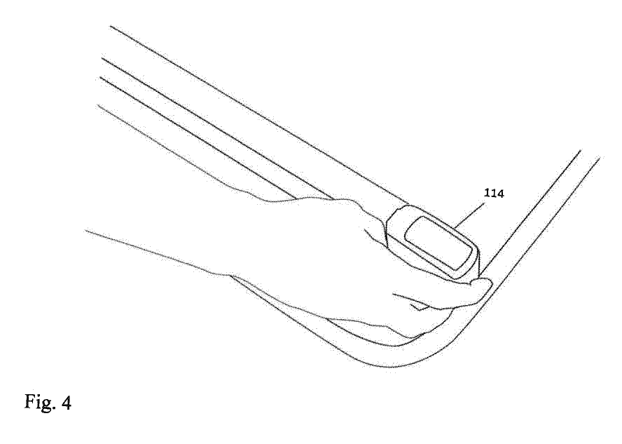

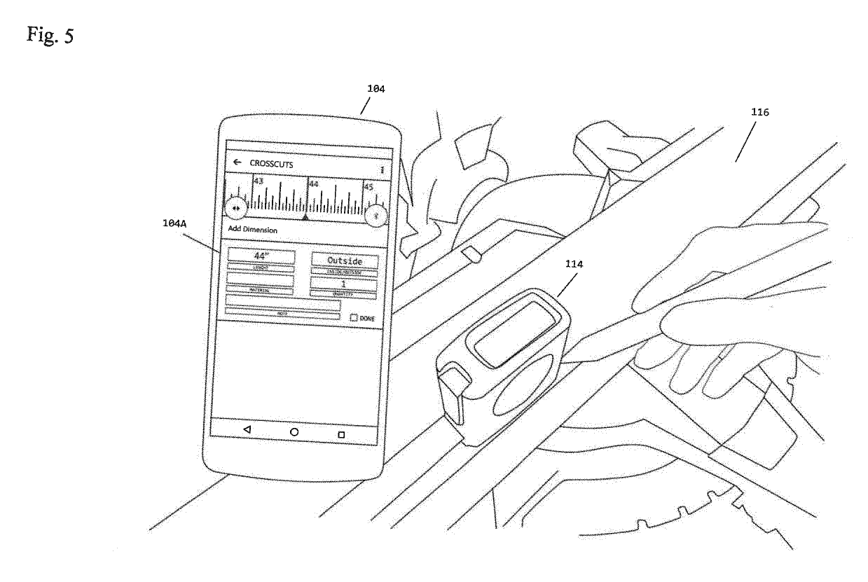

FIGS. 2 and 3 illustrate examples of computing devices 104 programmed with a processing application 104A configured to receive data from electronic measurement devices 114. FIG. 4 illustrates an example of an operator using a measurement device 114 to measure the length of a piece of wood. With regard to FIG. 5, work piece data can be obtained from the work piece environment 116 with the measurement device 114 and can be communicated to the processing application 104A, as shown on the screen display of the mobile computing device 104. FIG. 6 includes an example of the computing device 104 programmed with the processing application 104A (visually enlarged for clarity of illustration).

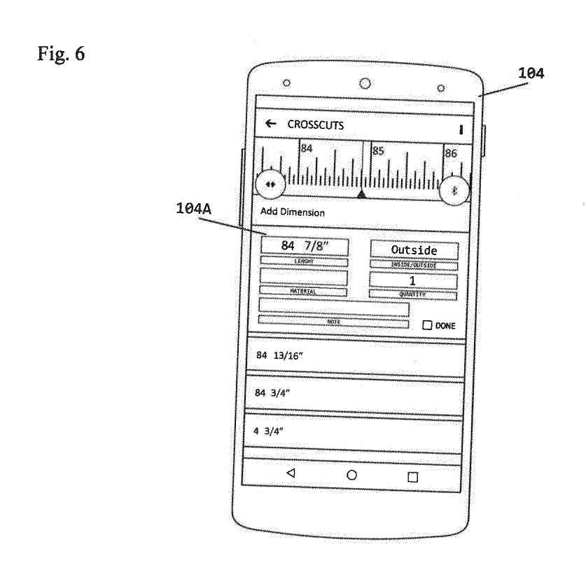

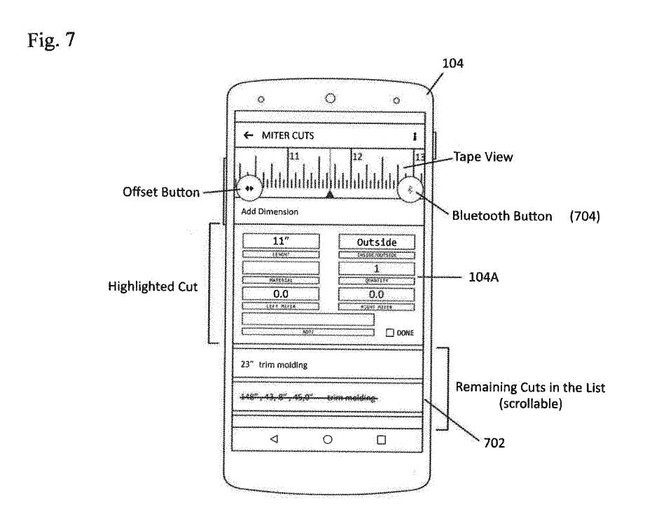

With reference to FIGS. 7 and 8, an example of a cut-list 702 is shown as presented by the processing application 104A on the screen display of the computing device 104. The cut-list 702 provides a list of cuts to be made on the work piece processing equipment 110 (e.g., saw cuts), including both those cuts that have been completed and those that have yet to be completed. As shown, one or more of the items in the cut-list 702 may be highlighted on the display. Also shown in this example is a wireless connectivity button 704, such as for enabling communication of data to a controller of a carriage assembly, for example. FIG. 8 points out the various pieces of information which can be associated with an item on the cut-list 702, as well as a cut completion feature 804 which allows a user to manually designate that a cut has been completed.

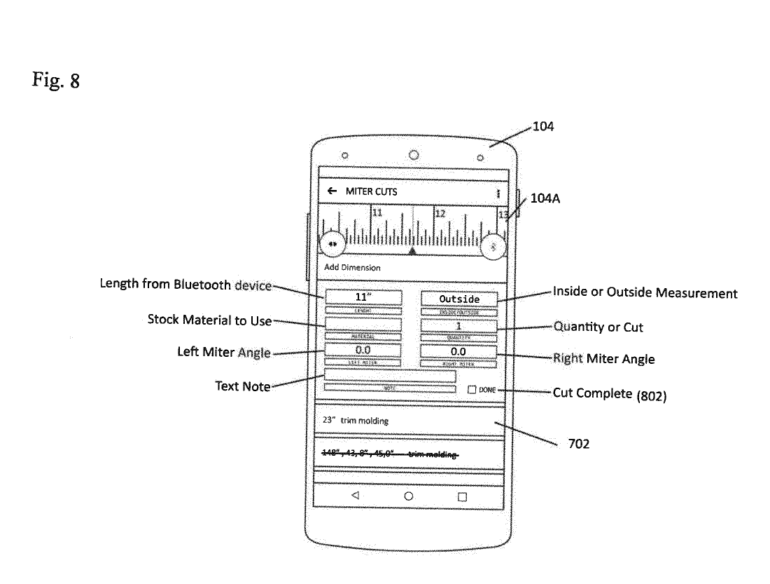

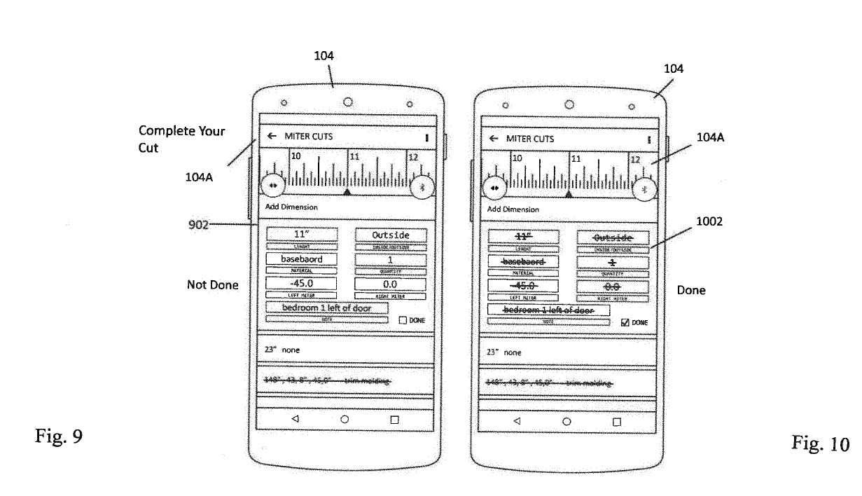

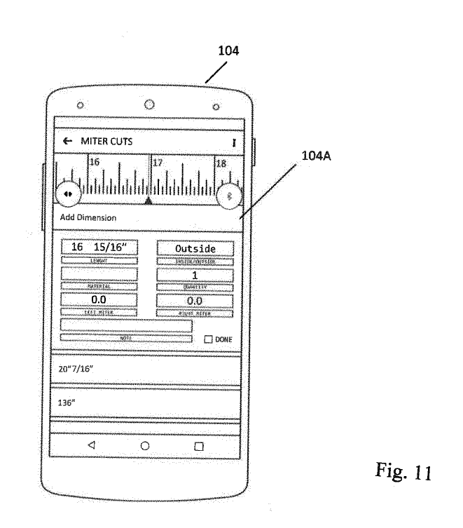

FIGS. 9 and 10 reflect a before and after situation involving a given item on the cut-list. FIG. 9 shows the cut-list item 902 prior to the cut being made; and FIG. 10 shows the cut-list item 1002, now reflecting strike-through text, after the cut has been made. In operation, the controller 106 or other software associated with the carriage assembly 108 installed on the work piece processing equipment 110 may communicate data associated with the cut-list item 902 after the act of cutting has been completed on the work piece processing equipment 110 to update the cut-list on the computing device 104. FIG. 11 includes another example of the computing device 104 programmed with the processing application 104A (visually enlarged for clarity of illustration).

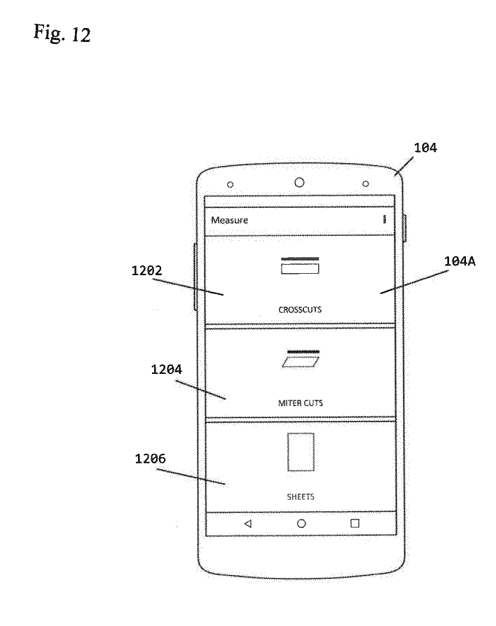

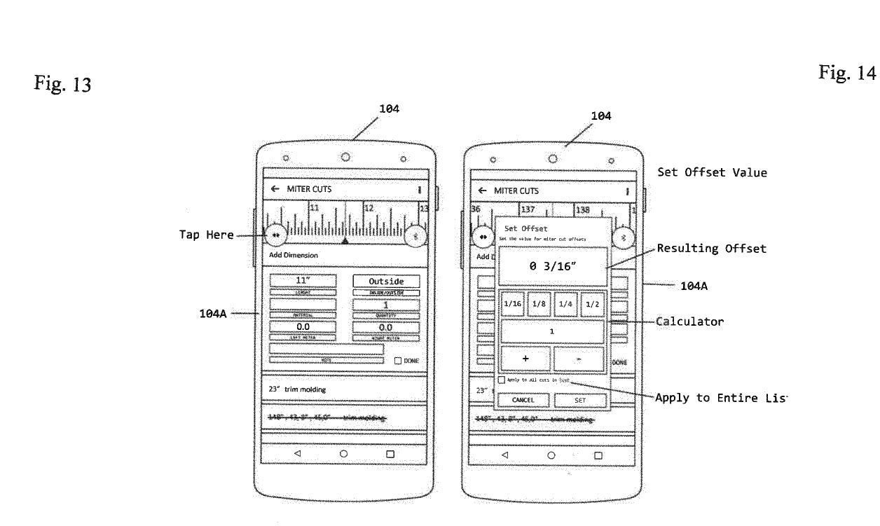

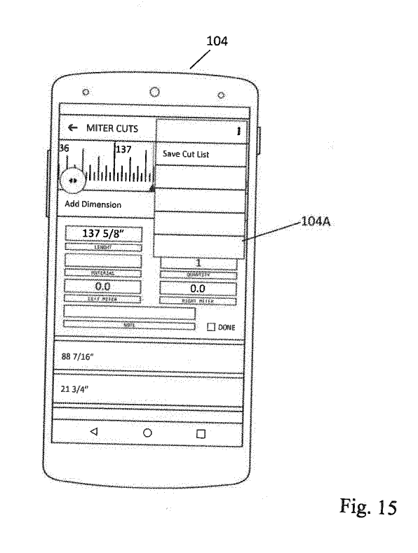

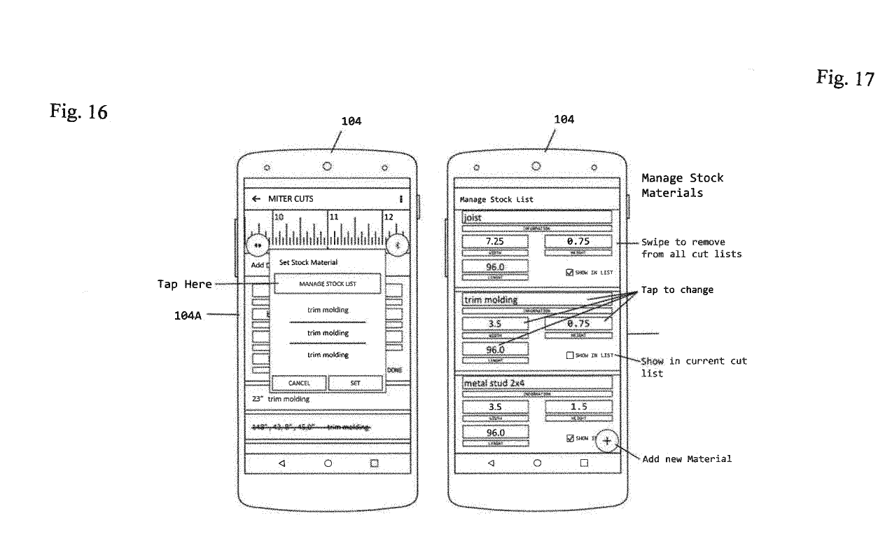

FIG. 12 illustrates an example showing the different kinds of cuts and materials which can be processed by the processing application 104A. Examples of cuts include crosscuts 1202 and miter cuts 1204. Also, two-dimensional materials such as sheets 1206 can be processed in various embodiments of the invention described herein. FIGS. 13 and 14 illustrate examples of setting an offset for different dimensions to be processed through the processing application 104A. FIG. 15 includes an example of saving or storing a cut-list to be communicated to the work piece processing equipment 110 from the computing device 104.

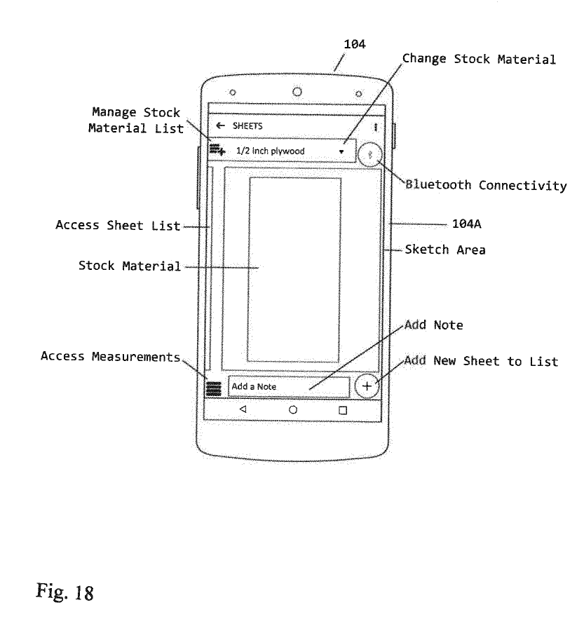

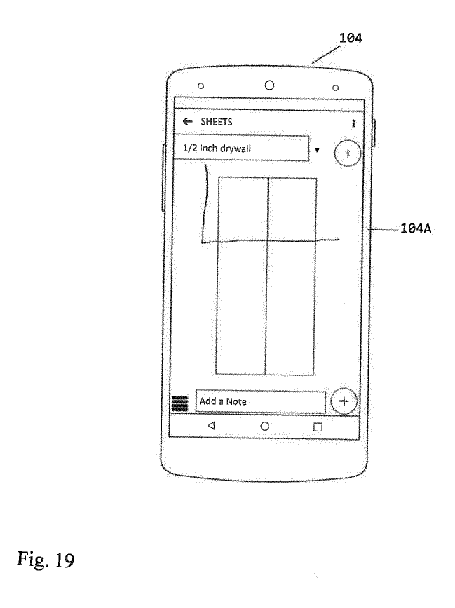

FIGS. 16 and 17 illustrate examples of managing a stock list with the processing application 104A. As shown in FIG. 16, a user can select a manage stock list feature 1602 using the computing device 104. FIG. 17 illustrates how attributes for various stock material items, such as joists, trim molding, metal studs, etc., can be customized and/or added to a cut-list with the processing application 104A as desired by the user. It can be seen that stock materials may be standard components used across different projects and may be defined by industry standards or by user-defined standards. Stock materials may also be defined by material that is available for the user to purchase at a nearby retail store.

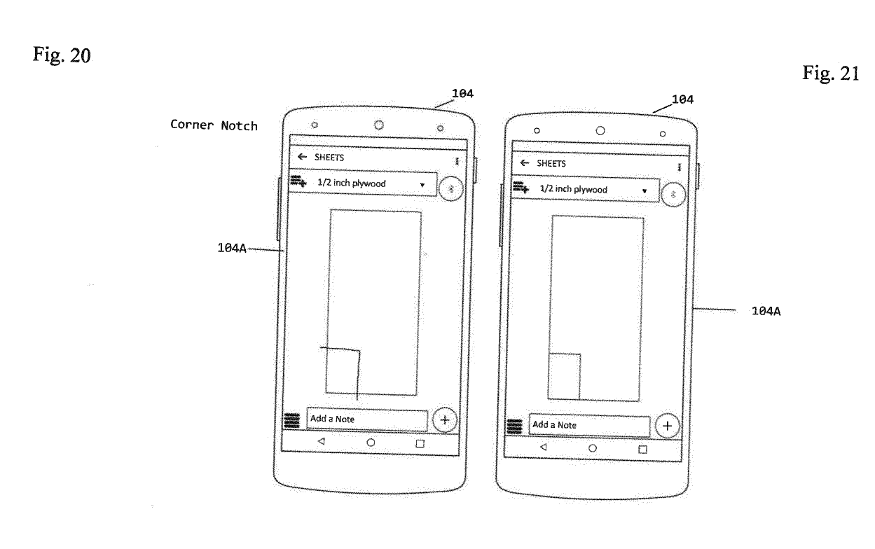

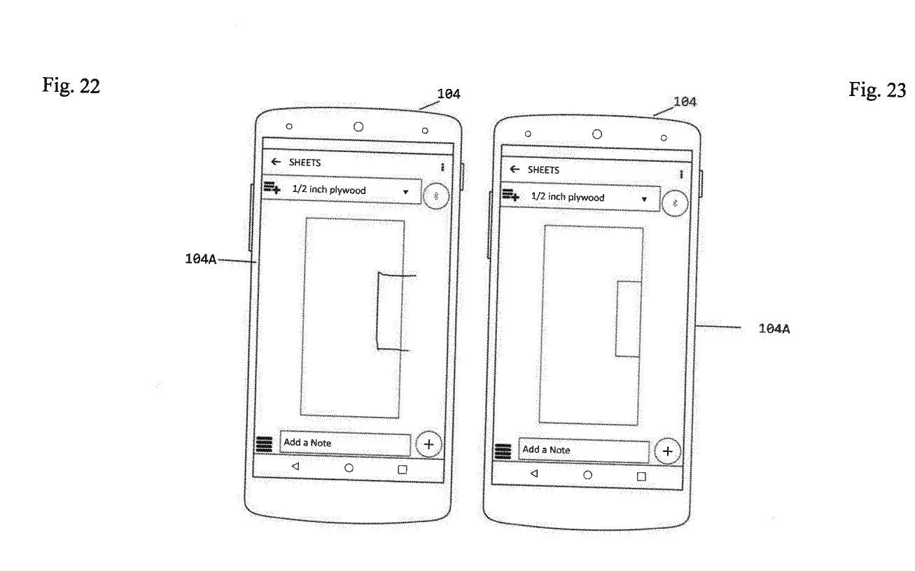

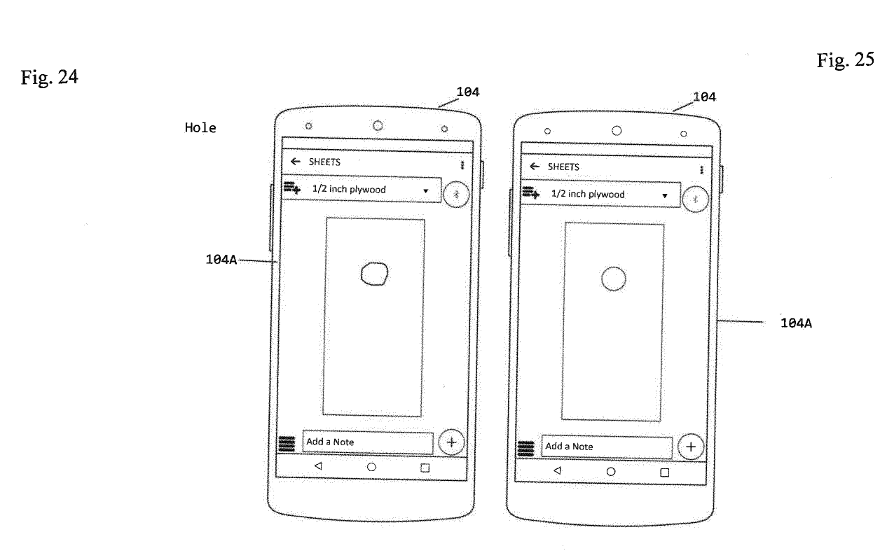

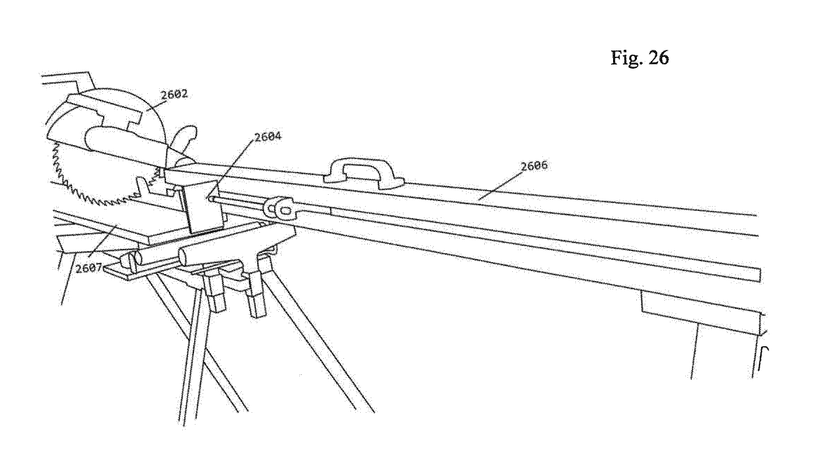

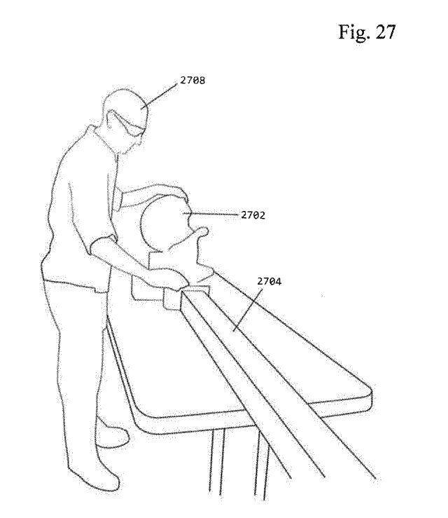

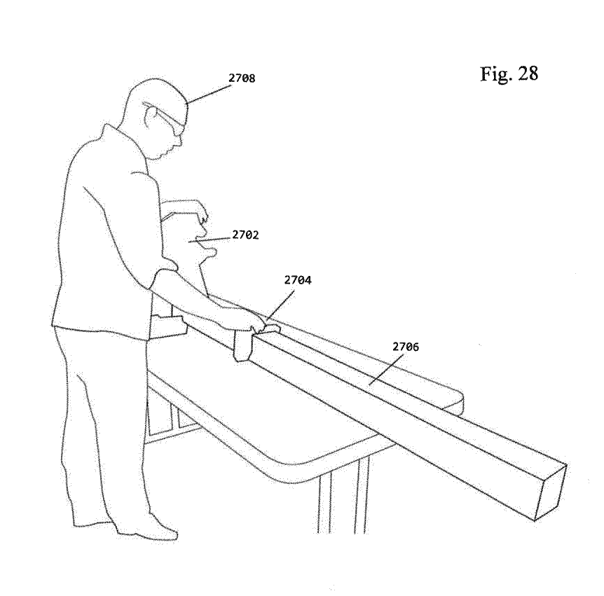

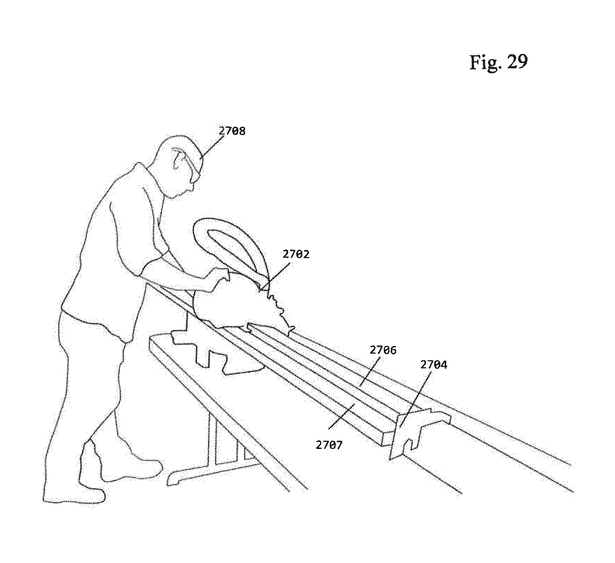

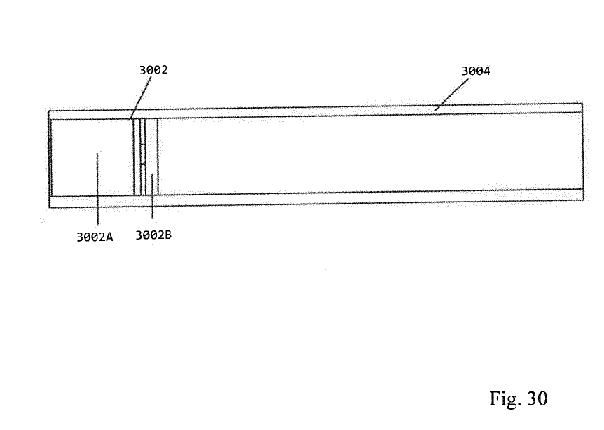

FIGS. 18 through 25 illustrate examples of a sketch tool that can be provided through the processing application 104A on the computing device 104. In the example shown, two-dimensional work piece materials such as drywall pieces or plywood can be visually represented on the screen display of the computing device 104. In operation, a user can manually (e.g., with a finger or stylus) interact with the visual representation to propose cuts to be made on the work piece. For example, FIG. 24 demonstrates the result of a user drawing a circle on the visual representation with a finger; and FIG. 25 represents how the processing application 104A correlates the user-drawn circle to a circle to be cut into the work piece. It can be appreciated that dimensions derived by the processing application 104A from the sketch tool can be correlated with dimensions of items on a cut-list including specific cuts to be performed on the work piece processing equipment 110.

In various embodiments, if a cut-list is not already present, the worker may use any of a suite of connected measurement tools or may manually enter the desired length or other dimension(s) of the cut. In addition to cut length, the cut-list can also provide other cut data such as part numbers, quantity, miter/compound angles, stock type, tolerances, blade speed/type, etc. This allows for optimal use of the work piece processing equipment 110, for example, by the worker. It can be seen that the computing device 104 and the processing application 104A are able to keep track of cuts, thus allowing the worker to create a reproducible cut-list. This can prove useful in preserving and/or sharing fabrication designs with a larger community. Similarly, a worker can also download a design and start fabricating it without the need to take measurements. The ability to interact with cloud computing resources provides access to a whole suite of design tools and software to keep track of stock/inventory and to estimate the cost of a project before starting fabrication. The cut-list need not be limited to simple stock lumber. The ability to download and fabricate designs means that manufacturers can ship partially finished, yet highly customizable furniture to a customer that is keen on building their own personalized pieces but does not have the full suite of expensive tools to build complex pieces from scratch.

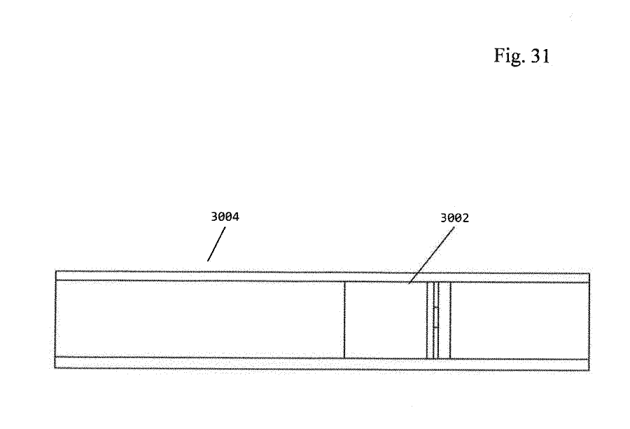

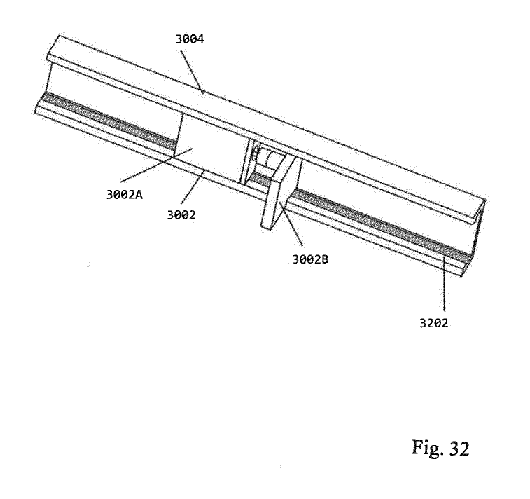

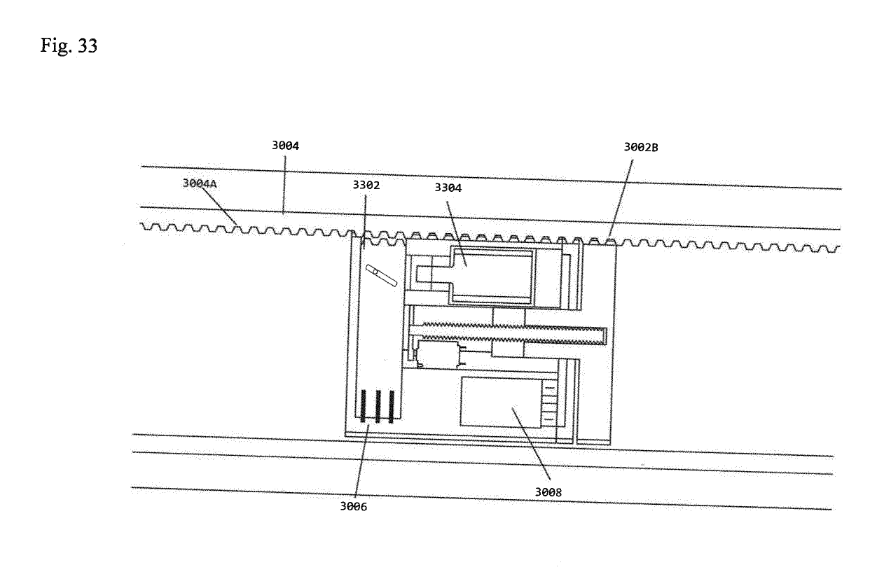

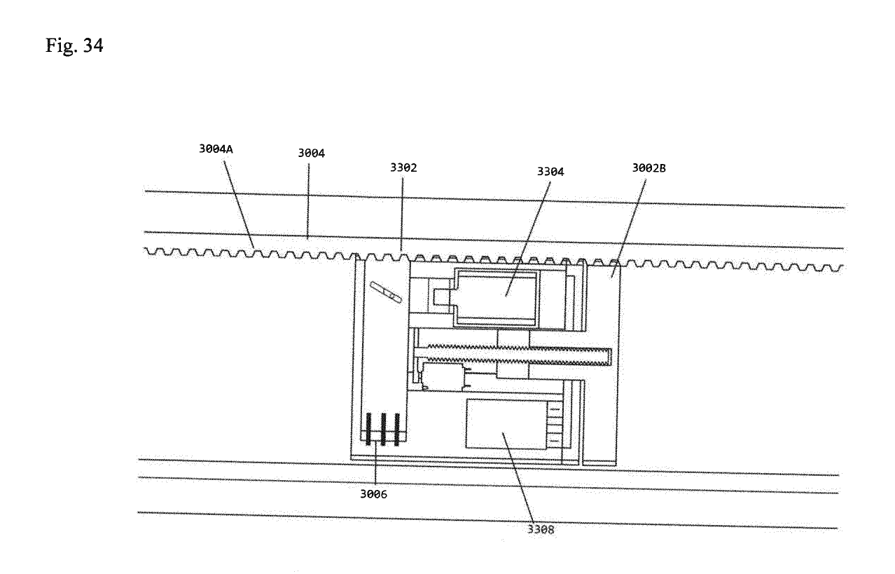

With reference to FIGS. 26 through 29, examples are provided of operation of certain embodiments of the invention. In these examples, table saws 2602, 2702 are shown in connection with stops 2604, 2704 and guide rail assemblies 2606, 2706 (respectively) that determine the position of work pieces 2607, 2707 to be cut. The guide rails 2606, 2706 attach to either side of the miter saws 2602, 2702, and the stops 2604, 2704 move along the lengths of the guide rails 2606, 2706 (respectively). Each of the stops 2604, 2704 may be a block positioned perpendicular to the guide rails 2606, 2706. This combination forms a rigid reference frame in which the work piece can be placed such that it is firmly pushing against both the guide rail 2606, 2706 and the stop 2604, 2704. This allows a worker 2708 to make repeatable and precise cuts of any desired length. A guide rail 2606, 2706 may comprise one component or a series of components mechanically affixed to the cutting device or saw 2602, 2702. As shown in the figures, and as described in more detail below, each guide rail assembly 2606, 2706 may include a housing, a structural guide rail, an optical measurement pattern, and a brake rack in addition to other components which may be required to mechanically connect a series of guide rails 2606, 2706 together (e.g., in a modular state) and/or to other components.

Various embodiments of the present invention provide an actuation mechanism that does not need a dedicated motor to move a carriage assembly 108 having a stop block 2604, 2704 along the guide rail 2606, 2706 of the saw 2602, 2702. Instead, the user can manually slide the stop block 2604, 2704 into its approximate position. An automatic brake (see discussion below) on the carriage assembly 108 engages, such that the stop blocks 2604, 2704 are rigidly held in the precise position until the desired cut is completed. In this manner, the worker 2708 can move the saw 2602, 2702 at a quick and comfortable speed until the brake engages. The carriage assembly 108 can also include a fine-positioning mechanism (see discussion below) that resists the possibility of under or over travel of the stop block 2604, 2704 from a desired distance from the blade of the saw 2602, 2702 (e.g., this distance is typically the cut length). In certain embodiments, the guide rail 2606, 2706 is designed to have teeth similar to a gear rack that mesh with a brake pad portion of the carriage assembly 108. This allows for an interlocking surface, as well as a rigid connection of the stop block 2604, 2704 to the guide rail 2606, 2706. This positioning and braking mechanism also reduces or eliminates the need for periodic service such as belt or chain tensioning (which are unnecessary components in this system), and the positioning system helps to avoid errors caused by backlash.

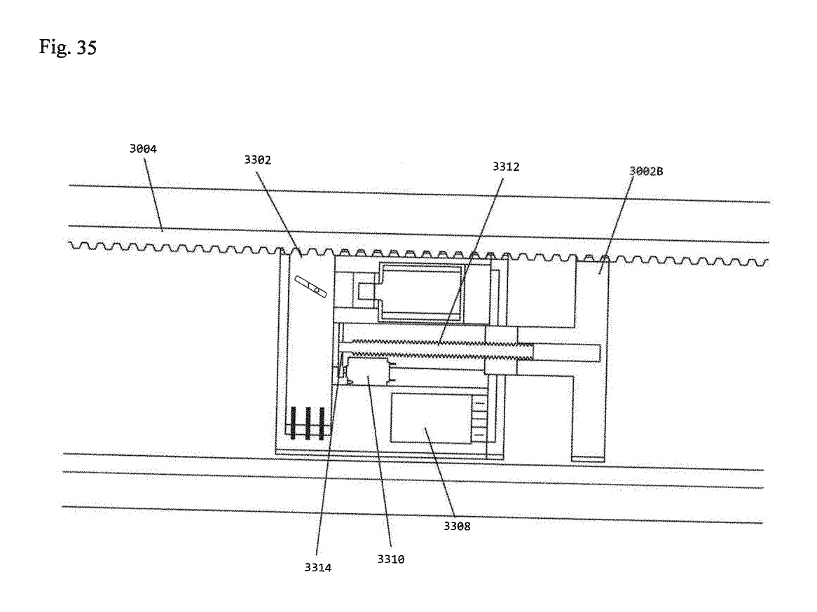

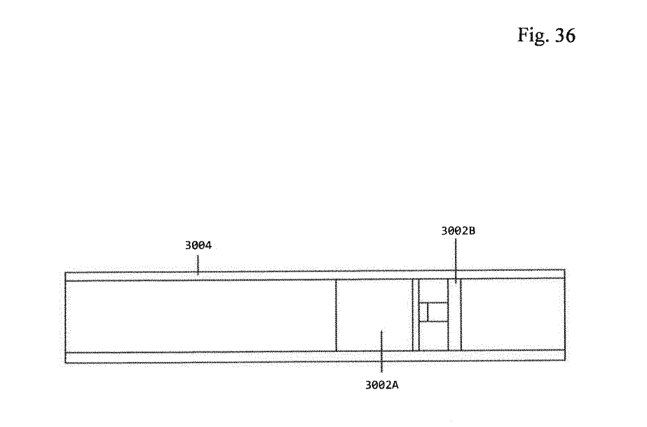

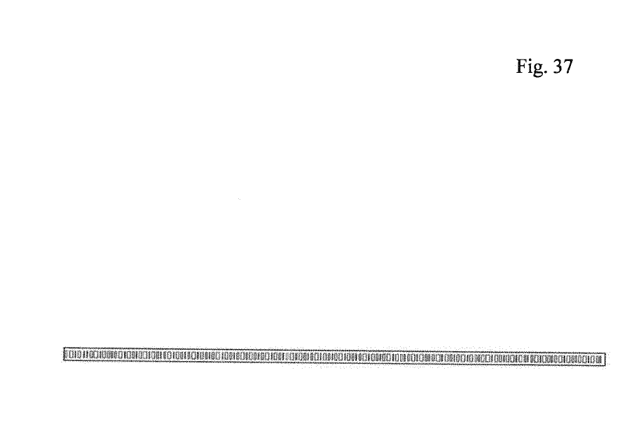

With regard to FIGS. 30 through 36, examples are provided of certain aspects of the operation of a braking and positioning mechanism contained within a carriage assembly 3002 installed on a guide rail 3004 on work piece processing equipment (e.g., cutting device or saw). A greater guide rail assembly may include the mechanism for affixing the guide rail 3004 to the cutting device or saw, as well as a leg assembly which provides a means of adjusting the height of the guide rail 3004 to align to the height of the cutting device or its stand.

In the examples shown, the carriage assembly 3002 includes an enclosure 3002A and stop block 3002B. In various embodiments, it can be seen that it is optimal to know the position of the stop block 3002B as precisely and quickly as possible to properly engage a brake 3302 of the carriage assembly 3002 at the correct moment. In order to position the stop block 3002B, an optical detection system may be operatively associated with the stop block 3002B and configured to interact with an optical measurement pattern 3202 positioned on the guide rail 3004. In certain embodiments, the optical detection system may employ two or more photodiodes that track the pattern 3202, which can be embodied as a coded high contrast pattern printed along the length of the guide rail 3004. The photodiodes allow the carriage assembly 3002 to track changes in the pattern 3202 as the stop block 3002B moves along the guide rail 3004. The unique sequence of changes in the pattern 3202 can be used to instantaneously compute the position of the stop block 3002B along the guide rail 3004. Thus, the automatic brake 3302 can be engaged when the stop block 3002B is at or near the desired distance from the saw blade (wherein the distance represents a cut length, for example, of a work piece). The optical measurement pattern 3202 may be printed, painted, etched, powder coated, or adhesively affixed onto the guide rail 3004.

In certain embodiments, error correcting codes may be employed in the pattern 3202, to promote robustness of the positioning system in view of the guide rail 3004 potentially being scuffed, scratched, or impacted by dust accumulation. The error correction also guards against electrical noise thus reducing the cost and complexity of the power supply. In operation and use, the positioning mechanism can provide an absolute position of the stop block 3002B on the rail 3004. In one embodiment, the positioning mechanism may be configured with a coarse position resolution no coarser than 1/64th of an inch, and an absolute or fine positioning accuracy no worse than ± 1/32nd of an inch.

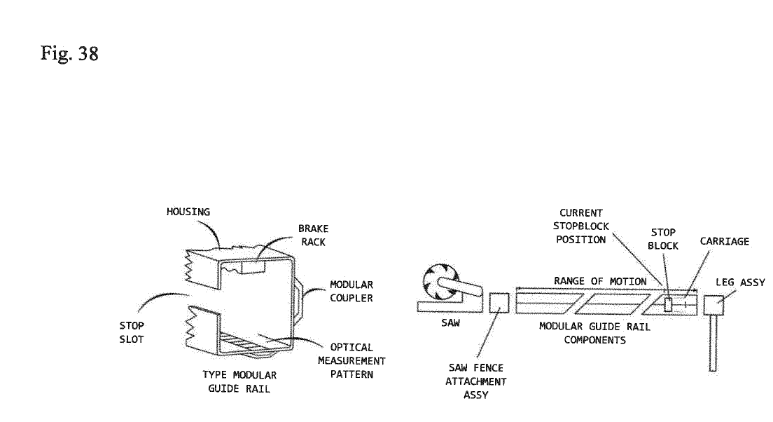

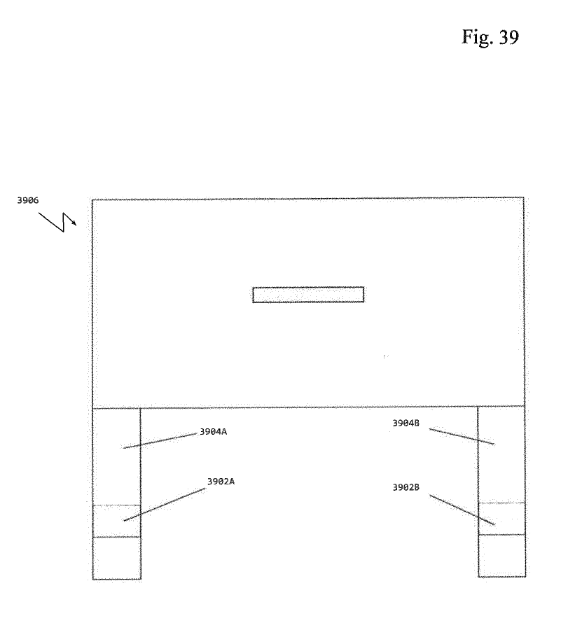

In this example, FIGS. 30 through 32 show the carriage assembly 3002 traveling along the guide rail 3004, with the stop block 3002B interacting with the optical measurement pattern 3202. As shown in more detail in FIG. 33, the brake 3302 can be actuated by use of a brake solenoid 3304 and assisted into place during a braking event by the spring-loaded action of one or more normally compressed springs 3306. A controller 3308 includes hardware, firmware, software, or other computer-executable instructions which can receive cut-list data, for example, from the processing application 104A. The controller 3308 can also be programmed to process data received from the optical detection system to direct the operation of the brake 3302, for example. FIG. 34 illustrates an example of engagement of the brake 3302 with the gear rack portion 3004A of the guide rail 3004.

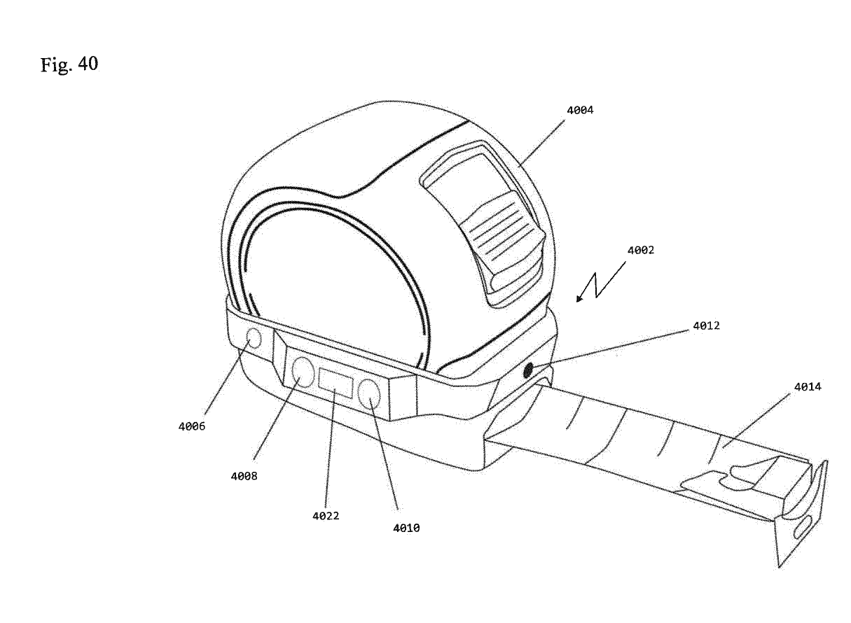

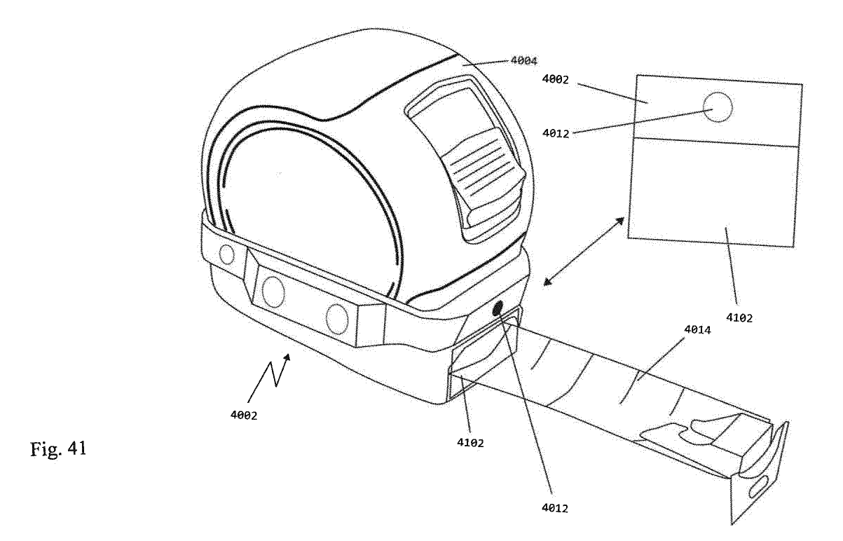

FIGS. 35 and 36 illustrate an example of the fine positioning system portion of the carriage assembly 3002. As shown, the controller 3308 processes data regarding an absolute position at which stop block 3002B is to be positioned along the guide rail 3004. The controller 3308 may be configured to direct the action of a fine adjustment motor 3310, which is mechanically coupled to a fine adjustment screw 3312 through a gear box 3314. The fine adjustment screw 3312 is coupled to the stop block 3002B and rotates in response to action of the motor 3310 to extend or retract the stop block 3002B in position along the guide rail 3004. For a single cutting operation, the brake 3302 may engage and disengage more than once. The first engagement of the brake 3302 may be to notify the user to stop manually sliding the stop block 3002B along the guide rail 3004. Then, the fine positioning mechanism can move the block 3002B into a final position prior to inserting the work piece into place at the desired distance from the blade. It can be seen that the fine positioning system may be configured with a limited range and speed of motion. As a result, the system can use an economical and comparatively lower power motor that is geared appropriately. This also results in a comparatively lower backlash gearing system.

Alternatively, actuation can be performed by a coarse-adjust mechanism. In this variation, the coarse-adjust mechanism moves the stop block 3002B in the appropriate direction with enough energy to reach the final location. The brake 3302 then engages as the stop block 3002B arrives to within a predetermined reach of the fine-positioning mechanism, which functions to move the stop block 3002B to the precise location. The coarse-adjust mechanism's actuator may be engaged during the full time it takes to travel to the reach of the fine-adjust mechanism, or it may only be engaged for part of the time. The coarse-adjust mechanism's actuator may be, for example, an electric motor, a solenoid, or another rotational or linear actuation device.

In another variation, the actuation mechanism includes a belt-driven carriage assembly 3002. The belt drives the assembly 3002 either entirely by itself to the desired location, or it drives the carriage assembly 3002 to within reach of a fine-adjustment mechanism built into the carriage assembly 3002. The fine adjustment mechanism may include a brake, a drive motor, and a lead screw or some similar means of fine-adjustment actuation.

In various embodiments, power may be supplied to different components of the AutoSet system externally via 110/220 VAC electricity, for example, or internally via battery. The AutoSet system may include a means of charging the battery, and power can be converted to low voltage DC (5V to 36V) as needed. The voltage conversion and conditioning may be designed to take place within the electronics enclosure of the carriage assembly, for example.

To manage potential variation in the different saws or other processing equipment to which AutoSet system components can be connected, as well as deviations in mounting from use-to-use, the system can be calibrated each time it is set up. To calibrate, the user enables calibration mode on the computing device, and the positioning mechanism moves to a pre -determined length. The user can be prompted to make a measurement between the blade of the cutting device and the stop block with a distance measurement device connected wirelessly to the processing application 104A. When the measurement data is communicated from the distance measurement device to the processing application 104, the system associates that distance with the current distance as read by the positioning mechanism, completing the calibration process.

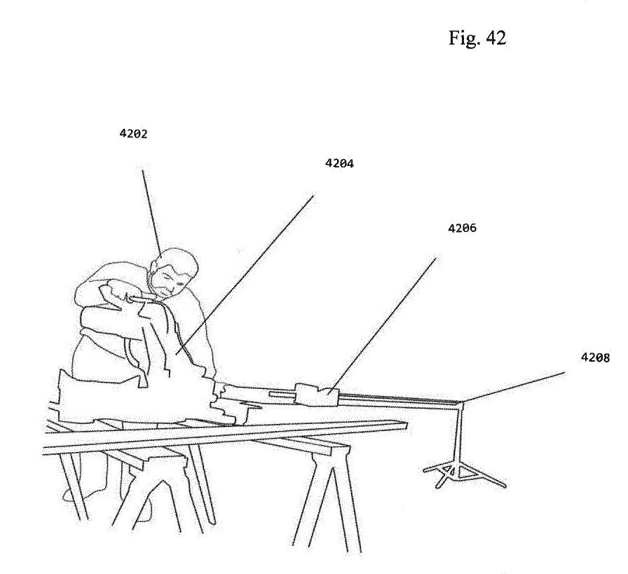

FIG. 37 includes an example of an optical measurement pattern that can be used in connection with certain guide rail and stop block embodiments described herein.

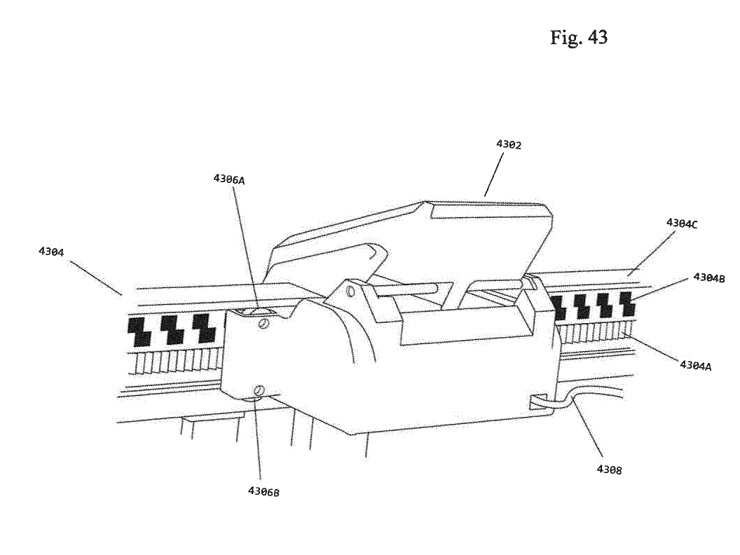

FIG. 38 illustrates examples of certain modular aspects of certain embodiments of the present invention. It can be sent that different actuation mechanisms described herein may be beltless and can be efficiently and quickly calibrated. For example, the length of a given guide rail can be changed by adding or removing modular segments. This modular nature of the system means that replacement of parts is affordable and the system may be readily portable between different work environments. It also allows for customization to use the system with a variety of cutting tools, routers, drill presses, or many other types of work piece processing equipment. Modularity also enables features such as folding the guide rail to provide portability and flexibility of use.

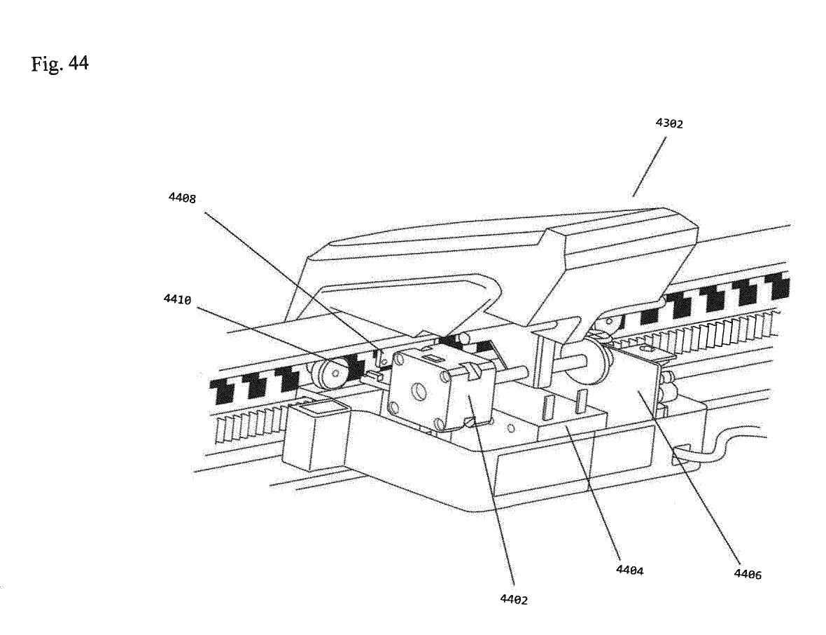

FIG. 39 illustrates an example of employing multiple carriage assemblies 3902A, 3902B structured for cooperative arrangement, such as for processing two-dimensional types of material such as sheet steel, plywood, dry wall, or other materials with multi-dimensional geometries. In this example, the carriage assemblies 3902A, 3902B travel along separate guide rails 3904A, 3904B (respectively) of the same work piece processing equipment 3906 (e.g., a table saw).

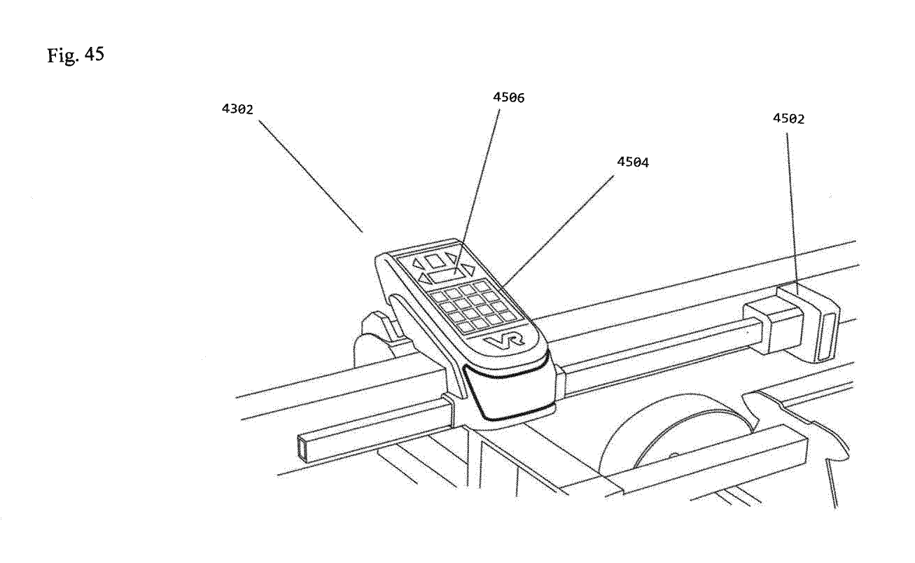

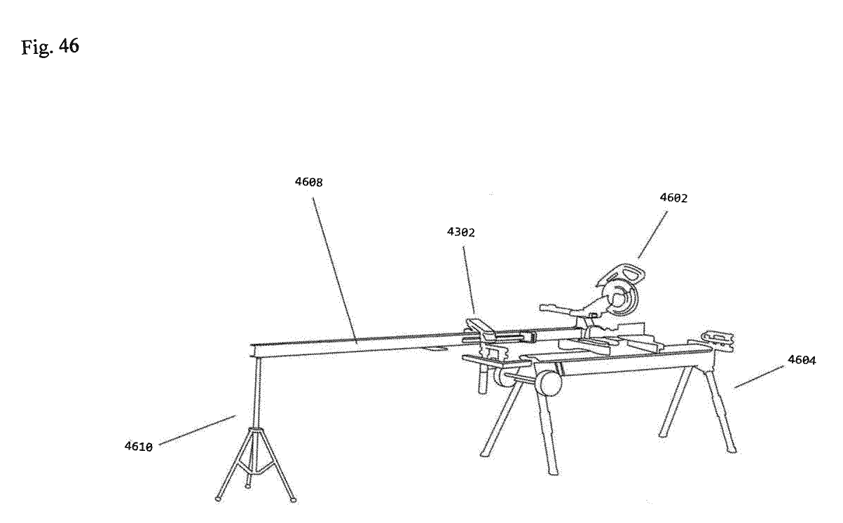

FIGS. 40 and 41 illustrate an example of an adapter sleeve 4002 which may be employed in connection with different kinds of tape measures. In the example shown, the sleeve 4002 has been positioned around the outside of a non-electronic tape measure 4004, which may be a trade-designated “Stanley” non-electronic tape measure, for example. The sleeve 4002 may be comprised of a rubber, plastic, and/or elastic material, and may be secured in place around the tape measure 4004 by clasps, catches, elastic force, or a variety of other suitable fasteners or fastening means. The sleeve 4002 can be appropriately structured to be retrofit or applied on a variety of different kinds of non-electronic tape measures. It can be appreciated that using the adapter sleeve 4002 provides an alternative to using potentially more expensive electronic tape measures 114.

In this example, the adapter sleeve 4002 includes a wireless communication button 4006 for pairing or connecting the sleeve wirelessly to a computer system or an electronic device such as a mobile device 104 programmed with a work piece processing application 104A, for example. The sleeve 4002 may also include first and second measurement capture buttons 4008, 4010 which can be activated to cause a camera 4012 to capture an image of at least a portion of a measurement portion 4014 of the tape measure 4004. The camera 4012 may be embodied as a camera or sensor typically employed in connection with a smart phone or similar mobile device 104, for example.

In certain embodiments, the first measurement capture button 4008 may be programmed to activate the camera 4012 in connection with capturing an image associated with an outside measurement of a work piece, for example. Similarly, the second measurement capture button 4010 may be programmed to activate the camera 4012 in connection with capturing an image associated with an inside measurement of a work piece, for example. One or more of the buttons 4006, 4008, 4010 may be sized or dimensioned sufficiently (e.g., made thicker or larger) to accommodate the fingers of a user wearing work gloves, for example.

In various embodiments, the adapter sleeve 4002 may include various software, firmware, and/or hardware components, such as for facilitating wireless communications, storing measurement data, operating the camera 4012, powering different functions of the sleeve 4002, and/or for performing other tasks or functions. In certain embodiments, the sleeve 4002 may include a screen display 4022 for displaying information to a user. For example, the sleeve 4002 may be programmed to process and display cut lists on the screen display 4002, or measurements which have been derived from the tape measure 4004. In such embodiments, it can be seen that the adapter sleeve 4002 can function in lieu of or in addition to embodiments of the processing application 104A described herein.

In other embodiments, FIG. 41 illustrates an example of a reference blade 4102 which can be attached to the adapter sleeve 4002. As shown, the reference blade 4102 is structured to extend from a bottom portion of the adapter sleeve 4002 toward the measurement portion 4014 of the tape measure 4004. In operation of the camera 4012 to capture images of the measurement portion 4014, the reference blade 4102 can provide an effective reference point for determining and deriving measurement data associated with the captured image.

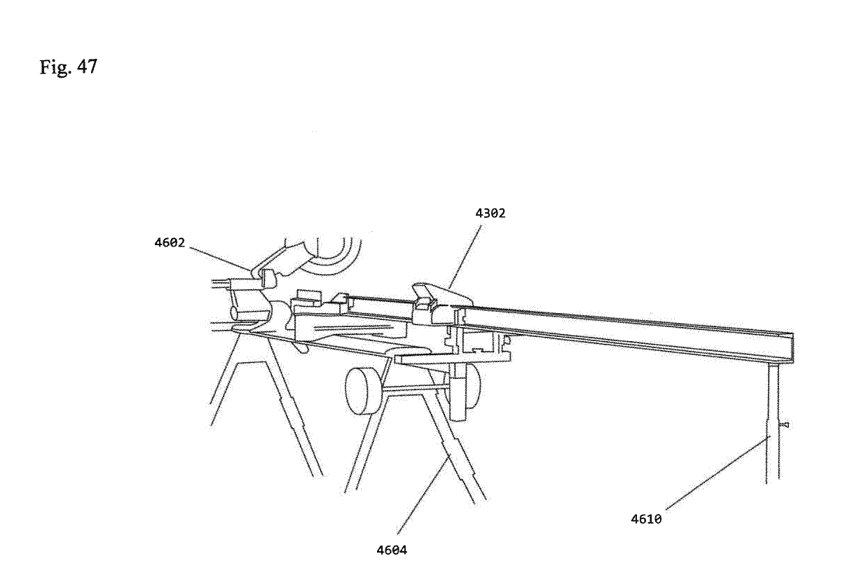

In other embodiments, FIG. 42 illustrates an example of a user 4202 cutting a work piece using one embodiment of the invention attached to a miter saw 4204. A carriage assembly 4206 is seen affixed to a guide rail assembly 4208 about one-third of the way between the miter saw and the end of the rail. The work piece (not visible) is pressed up against the fixed stop block of the carriage assembly 4208.

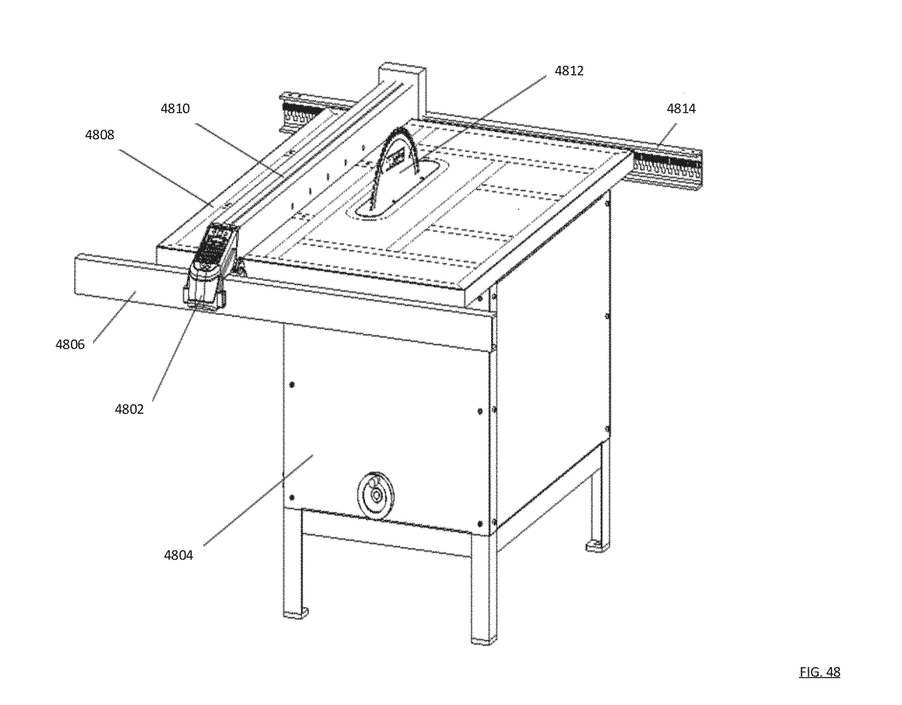

FIG. 43 illustrates one example of an implementation of the carriage assembly 4302 sitting inside the guide rail assembly 4304 as seen from a back view. A brake rack 4304A and coarse sensor pattern 4304B are seen affixed to a guide rail 4304C of the assembly 4304. In this example, the carriage assembly 4302 slides along the guide rail 4304C with the help of multiple rollers 4306A, 4306B. Power can be supplied at line voltage (110 VAC) via an extension cable 4308, for example. Fine adjustment positioning of the stop block of the carriage assembly 4302 can be enabled by a shaft connecting the top portion of the carriage assembly 4302 that flips over the guide rail 4304C and a base of the carriage assembly 4302, as shown. The brake rack 4304A can be used to fix the coarse position of the carriage assembly 4302 in conjunction with a solenoid-driven brake which is internal to the base of the carriage assembly 4302. The brake rack 4304A can also be used to secure the carriage assembly 4302 into the guide rail 4304C.

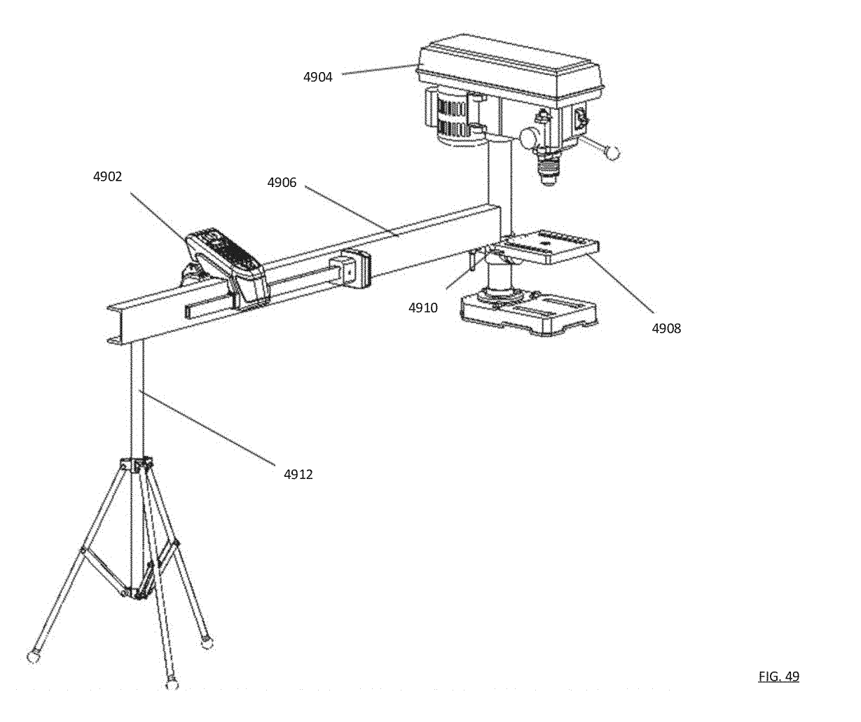

FIG. 44 illustrates a cut away view of the carriage assembly 4302 of FIG. 43. A stepper motor 4402 can be used for fine positioning adjustment of the carriage assembly 4302. A solenoid 4404 can be used to disengage the brake. A power supply printed circuit board 4406 can be used for transforming line voltage (110 VAC) to low voltage (12 VDC). Another printed circuit board 4408 can be used for reading the coarse sensing pattern. In another aspect, a brake block 4410 can be used for fixing coarse position of the carriage assembly 4302.

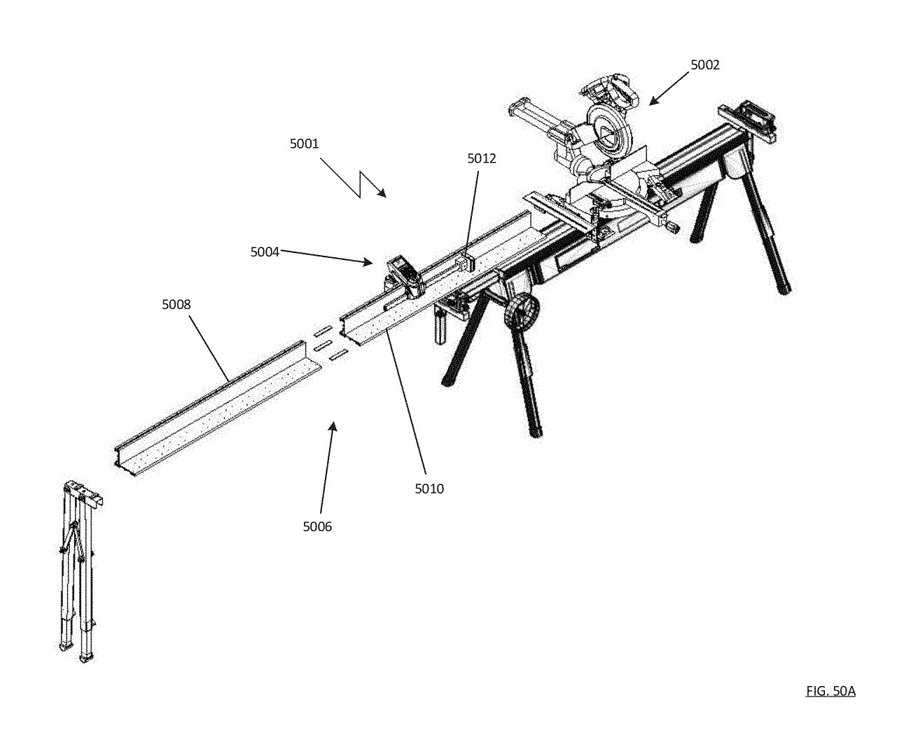

FIG. 45 illustrates a front top view of the carriage assembly 4302. In this view, the stop block is also visible, held in place by a rectangular tube, which is held in turn by the top of the carriage assembly 4302. An offset of the stop block 4502 from the carriage assembly 4302 can be adjustable and enables the stop block 4520 to get closer to the blade of the work piece processing equipment (e.g., a saw in this example). In this implementation, the top of the carriage assembly 4302 also contains a keypad 4504 for data entry, and a digital readout 4506 for displaying the current length setting, for example. In certain embodiments, jog buttons can be provided for finely adjusting the current length setting, and indicator lights can be provided for communicating the state of the device to the user, for example.

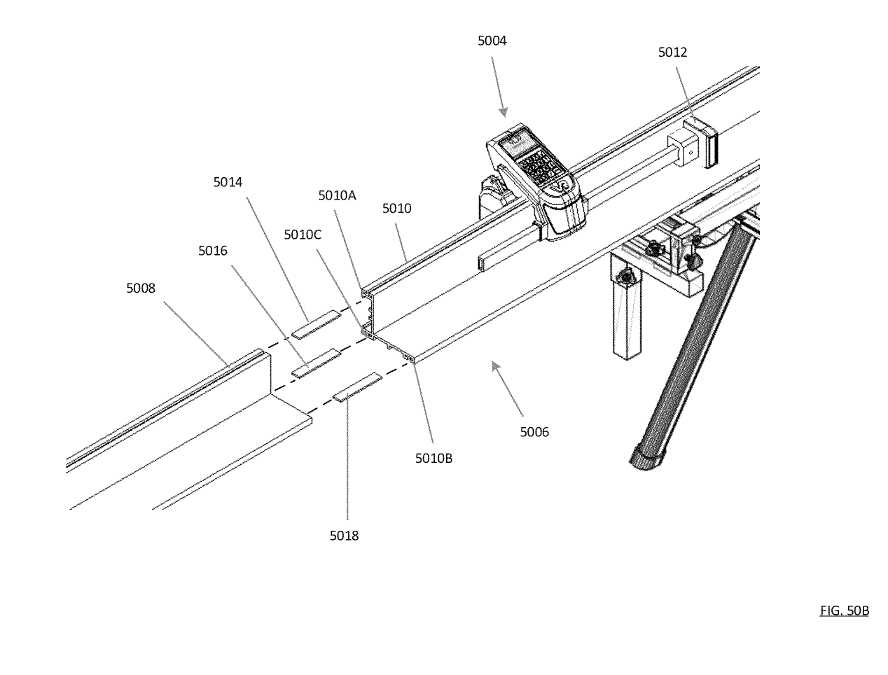

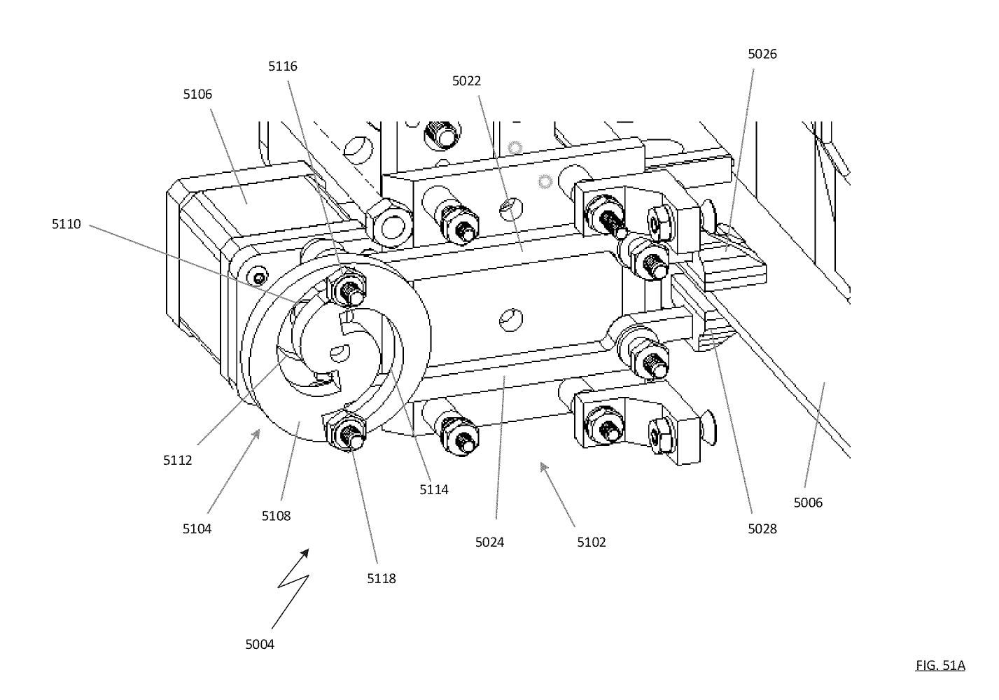

FIGS. 46 and 47 show the carriage assembly 4302 attached to a miter saw 4602, which is attached to a stand 4604 typically used on construction sites, for example. The end of the guide rail assembly 4608 opposite the miter saw 4602 is supported with a tripod 4610. In this implementation, the guide rail assembly 4608 is made up of two sections attached in the middle with a bracket, seen just under the “VR” logo near the middle of the rail assembly 4608.

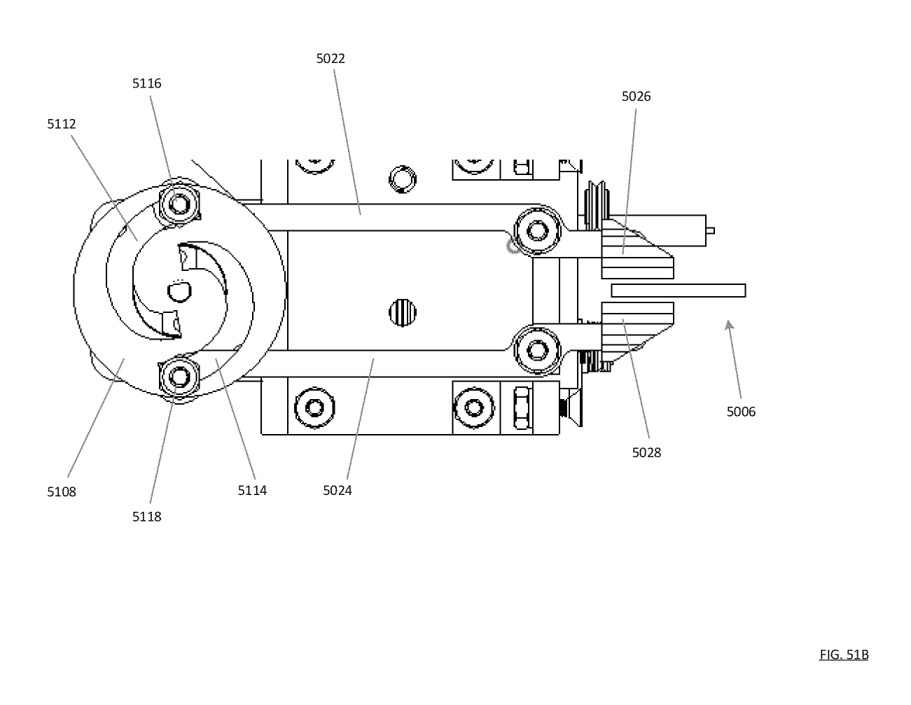

In another embodiment, FIG. 48 depicts a carriage assembly 4802 affixed for operation with a table saw 4804. In this embodiment, a guide rail 4806 is affixed below the table saw work surface 4808 to work cooperatively with the carriage assembly 4802. The carriage assembly 4802 may be connected for operative association with a stop rail or fence assembly 4810 positioned on top of the table saw work surface 4808 with its longitudinal axis parallel to the plane of a blade 4812 of the table saw 4804. Optionally, a second guide rail 4814 can be mounted in a generally parallel and opposing alignment with respect to the first guide rail 4806, in order to promote retaining the fence assembly 4810 in a generally parallel position with respect to the blade 4812.

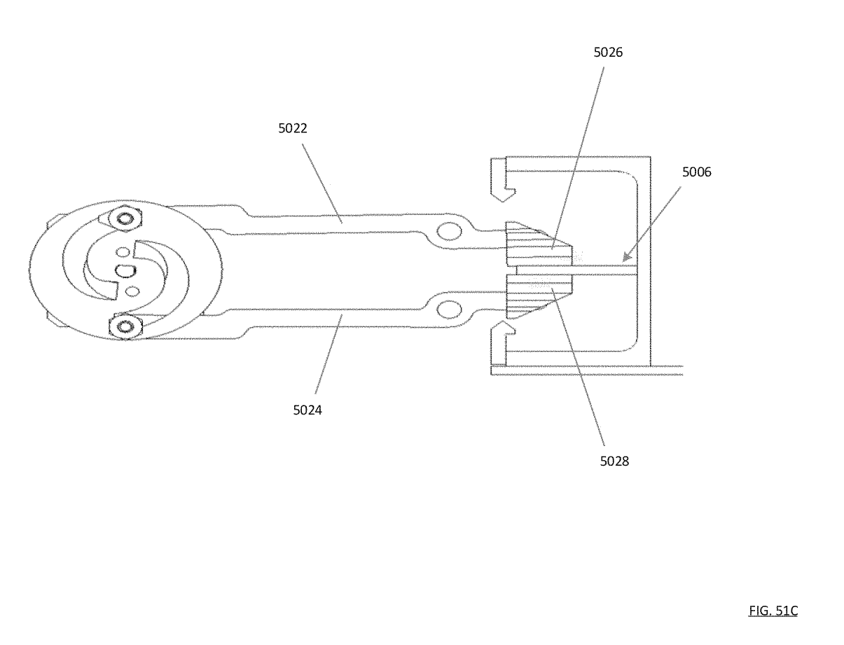

In a further embodiment, FIG. 49 depicts a carriage assembly 4902 affixed for operation with a drill press 4902. In this embodiment, a guide rail 4906 is affixed to a work surface 4908 of the drill press 4904. As shown, the carriage assembly 4902 can be configured to move correspondingly vertically as the drill press work surface 4908 is moved up or down, for example. The carriage assembly 4902 moves along the guide rail 4906 as in other examples described herein. Optionally, a quick-release clamp 4910 can be used to secure the guide rail 4906 to the drill press work surface 4908 to allow convenient connection or disconnection of the guide rail 4906 from the drill press 4906. In certain embodiments, the combination of the carriage assembly 4902 and the guide rail 4906 may be supported in place by use of a work stand 4912, for example.

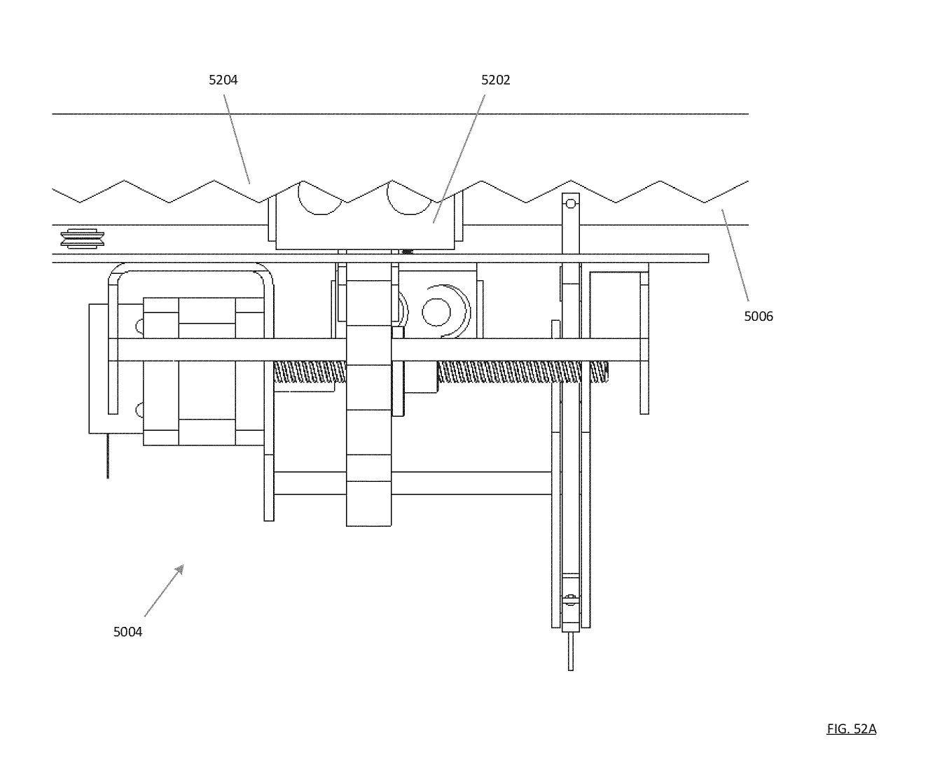

With regard to FIGS. 50A through 52B, another example of a work piece positioning system 5001 is shown as structured in accordance with certain embodiments of the invention for operative association with a saw 5002, for example. FIG. 50A illustrates a work piece positioning system 5002 including a carriage assembly 5004 and a guide rail assembly 5006, with the carriage assembly 5004 structured to slidably engage and move along multiple guide rails 5008, 5010 of the guide rail assembly 5006. A stop block 5012 provides a surface suitable for receiving and maintaining a work piece (e.g., the end portion of a piece of lumber) against the surface, such as during the process of cutting the work piece with the saw 5002, for example.

In this embodiment, it can be seen that the modular nature of the system 5001 can be embodied as multiple segments of the guide rail assembly 5006. For example, the multiple guide rail segments 5008, 5010 may each possess multiple channels (e.g., channels 5010A -5010C) structured to receive shims 5014, 5016, 5018 therein (respectively). The shims 5014, 5016, 5108 may comprise a material such as plastic or metal, for example, among other types of suitable materials. The shims 5014, 5016, 5018 can be structured for connectably engaging in a tongue and groove manner, for example, the different segments 5008, 5010 of the guide rail assembly 5006 to each other.

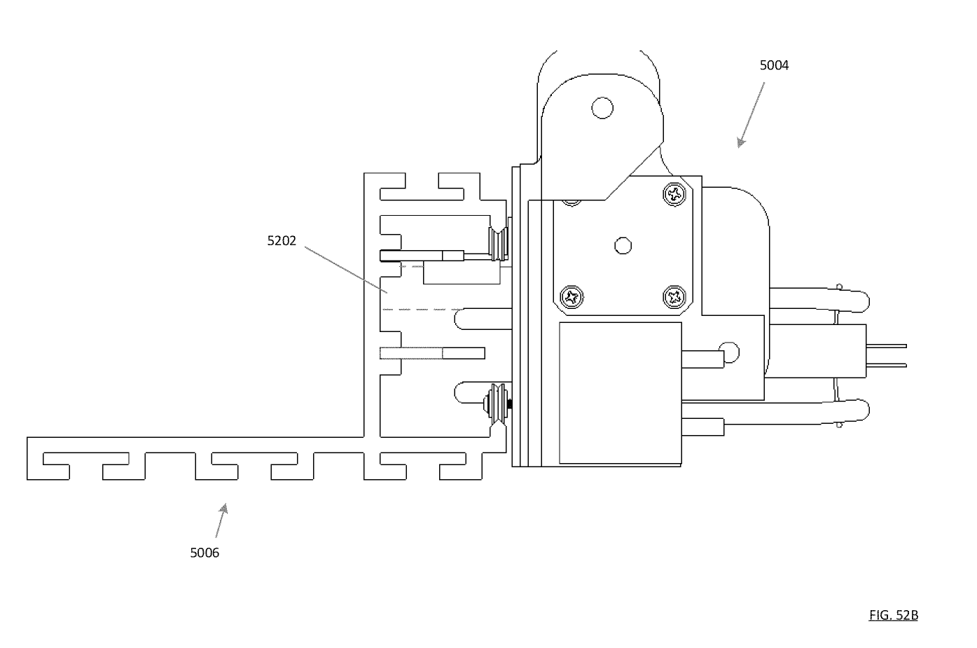

With regard to FIGS. 51A-51C, in other aspects of the present invention, examples of different embodiments of a braking and positioning mechanism 5102 of the carriage assembly 5004 are illustrated. In the example shown, the braking and positioning mechanism 5102 includes a braking system 5104 comprising a stepper motor 5106 engaged with a rotatable disc 5108 through a cam shaft 5110. As shown, the rotatable disc 5108 includes ramps 5112, 5114 having pins 5116, 5118 extending through the ramps 5112, 5114 (respectively). The pins 5116, 5118 connect and operatively associate the rotatable disc through brake arms 5022, 5024 (respectively). Brake pads 5026, 5028 are mounted on the brake arms 5022, 5024 (respectively) and are operably engageable with various portions of the guide rail assembly 5006. In operation, when the carriage assembly 5004 has determined or has received data reflecting a desired position, the stepper motor 5106 can be activated to turn the rotatable disc 5108, thereby drawing the brake arms 5022, 5024 and their respective brake pads 5026, 5028 into a closed or clamped position on a portion of the guide rail assembly 5006. The action of the brake pads 5026, 5028 serves to stop the carriage assembly 5004 at a location corresponding to the desired position. FIG. 51C illustrates an example of the brake pads 5026, 5028 in a closed state or position.

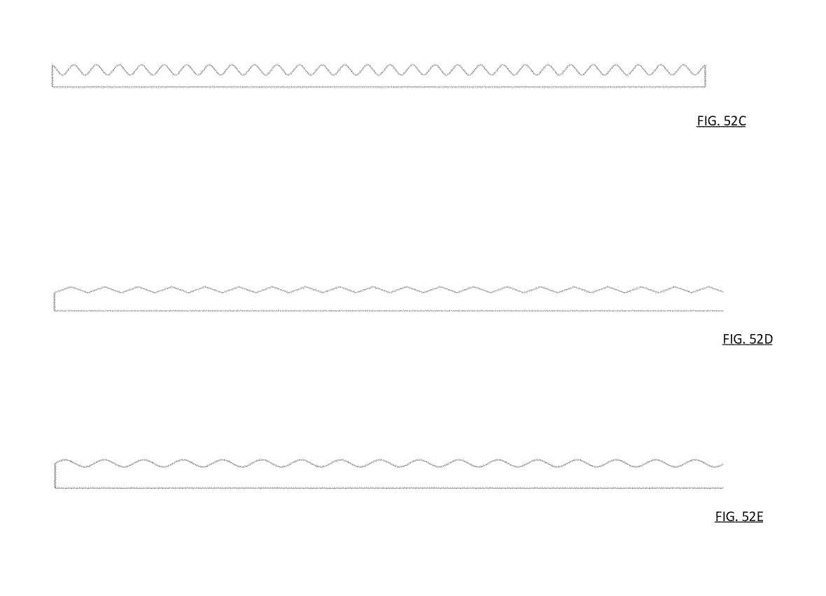

With regard to FIGS. 52A and 52B, in other aspects of the present invention, an inductive sensing detection system 5202 may be configured to interact with a shaped-metal pattern variety of measurement pattern 5204 associated with or connected to the guide rail assembly 5006. In various embodiments, the inductive sensing detection system 5202 comprises a sensor board having one or more multiple inductive coils therein, along with a computer chip programmed to detect current induced in the inductive coils. For example, the computer chip may a trade-designated “LDC1000 Inductance-to-Digital Converter” (offered by Texas Instruments, www.ti.com). In operation, as the carriage assembly 5004 moves and the sensor board of the detection system 5202 passes across the metal pattern 5204, and changes in the pattern 5204 can be detected based on the amount of metal detected in the pattern 5204. The amount of metal detected by the detection system 5202 can induce a current in the inductive coils which can in turn be detected and processed by the computer chip. In this manner, a distance from the saw 5002, for example, can be calculated by operation of the detection system 5202 to analyze the pattern 5204, and thereby determine the current position of the carriage assembly 5004 or its associated components on the guide rail assembly 5006 relative to the saw 5002.

FIGS. 52C-52E illustrate various embodiments of different potential geometries for the pattern 5204 which represent different frequencies for the pattern 5204 as it interacts with the detection system 5202 during travel adjacent to the pattern 5204. FIG. 52C illustrates an example of a comparatively higher frequency sinusoidal wave for the pattern 5204. FIG. 52D shows an example of a comparatively higher frequency saw tooth wave which can be embodied in the pattern 5204. FIG. 52E illustrates an example of a comparatively higher frequency sinusoidal wave which can be embodiment for the pattern 5204. It can be appreciated that two or more such patterns may be combined or stacked to create customized or variable frequency profiles. Such customized frequency profiles can be selected in response to the interferometry characteristics yielded when multiple patterns are combined together. The combination can be selected in association with a desired level of accuracy and precision in the measurement desired to be obtained from the work piece positioning system 5001 for different applications.

It can be appreciated that the examples described herein are intended primarily for purposes of illustration of the invention for those skilled in the art. No particular aspect or aspects of the examples are necessarily intended to limit the scope of the present invention. For example, no particular aspect or aspects of the examples of system architectures, device configurations, material processing equipment (e.g., table saw), or process flows described herein are necessarily intended to limit the scope of the invention.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that a sufficient understanding of the present invention can be gained by the present disclosure, and therefore, a more detailed description of such elements is not provided herein.

Any element expressed herein as a means for performing a specified function is intended to encompass any way of performing that function including, for example, a combination of elements that performs that function. Furthermore, the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

In various embodiments, various models or platforms can be used to practice certain aspects of the invention. For example, software-as-a-service (SaaS) models or application service provider (ASP) models may be employed as software application delivery models to communicate software applications to clients or other users. Such software applications can be downloaded through an Internet connection, for example, and operated either independently (e.g., downloaded to a laptop or desktop computer system) or through a third -party service provider (e.g., accessed through a third-party web site). In addition, cloud computing techniques may be employed in connection with various embodiments of the invention. Moreover, the processes associated with the present embodiments may be executed by programmable equipment, such as computers. Software or other sets of instructions that may be employed to cause programmable equipment to execute the processes may be stored in any storage device, such as a computer system (non-volatile) memory. Furthermore, some of the processes may be programmed when the computer system is manufactured or via a computer -readable memory storage medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi -permanent and/or semi-temporary. Memory and/or storage components may be implemented using any computer-readable media capable of storing data such as volatile or non-volatile memory, removable or non-removable memory, erasable or non-erasable memory, writeable or re-writeable memory, and so forth. Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase -change memory, ovonic memory, ferroelectric memory, silicon-oxide-nitride-oxide-silicon (SONOS) memory, magnetic or optical cards, or any other type of media suitable for storing information.

A “computer,” “computer system,” “computing device,” “component,” or “computer processor” may be, for example and without limitation, a processor, microcomputer, minicomputer, server, mainframe, laptop, personal data assistant (PDA), wireless e-mail device, smart phone, mobile phone, electronic tablet, cellular phone, pager, fax machine, scanner, or any other programmable device or computer apparatus configured to transmit, process, and/or receive data. Computer systems and computer-based devices disclosed herein may include memory and/or storage components for storing certain software applications used in obtaining, processing, and communicating information. It can be appreciated that such memory may be internal or external with respect to operation of the disclosed embodiments. In various embodiments, a “host,” “engine,” “loader,” “filter,” “platform,” or “component” may include various computers or computer systems, or may include a reasonable combination of software, firmware, and/or hardware. In certain embodiments, a “module” may include software, firmware, hardware, or any reasonable combination thereof.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general-purpose processor or application specific processor. The embodiments, however, are not limited in this context.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

Certain embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary aspects and aspects shown and described herein.

Although various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those of ordinary skill in the art and, consequently, are not described in detail herein.

The flow charts and methods described herein show the functionality and operation of various implementations. If embodied in software, each block, step, or action may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flow charts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment. The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as claimed herein.

What is claimed is:

1. A work piece positioning system comprising:
a guide rail assembly structured for connection to an item of work piece processing equipment, the guide rail assembly comprising:
at least one guide rail, and,
a measurement pattern positioned on at least a portion of at least one guide rail; and
a carriage assembly structured for slidable engagement with at least a portion of the guide rail of the guide rail assembly, the carriage assembly comprising:
a controller configured for wireless data communication with at least one mobile computing device,
a stop block,
a braking and positioning mechanism configured for positioning the stop block in connection with a cutting operation to be performed on a work piece on the item of work piece processing equipment, and
a detection system configured to interact with the measurement pattern positioned on the guide rail assembly and to assist with positioning the stop block in a predetermined position on the guide rail assembly.

2. The system of claim 1, wherein the braking and positioning mechanism comprises a coarse-adjust mechanism and a fine-positioning mechanism, wherein the coarse -adjustment mechanism is configured to move the carriage assembly along the guide rail assembly to position the stop block within a predetermined reach of the fine-positioning mechanism.

3. The system of claim 2, wherein the fine-positioning mechanism is configured to move the stop block to a predetermined position on the guide rail assembly.

4. The system of claim 1, further comprising:
the measurement pattern comprises an optical measurement pattern;
the detection system comprises an optical detection system; and,
the controller is programmed to determine the position of the stop block in response to the interaction of the optical detection system and the optical measurement pattern.

5. The system of claim 1, further comprising:
the measurement pattern comprises a metal-shaped pattern;
the detection system comprises an inductive sensing detection system having a sensor board programmed to detect an amount of metal in the metal-shaped pattern; and,
the controller is programmed to determine the position of the stop block in response to the interaction of the detection system and the measurement pattern.

6. The system of claim 1, wherein the braking and positioning mechanism comprises a coarse-adjust mechanism and a fine-positioning mechanism, wherein the coarse -adjustment mechanism is configured to permit manually sliding the carriage assembly to within a predetermined reach of the fine-positioning mechanism.

7. The system of claim 1, wherein the controller is programmed to receive data communicated from an electronic measurement device.

8. The system of claim 1, wherein the controller is programmed to receive a cut-list including a list of cuts to be made on the work piece processing equipment.

9. The system of claim 1, wherein the controller is programmed to receive data derived from at least one information source associated with at least one dimension of a work piece or at least one attribute of a work piece environment.

10. The system of claim 1, wherein the controller is programmed to receive data associated with captured image data.

11. The system of claim 1, wherein the carriage assembly comprises at least one automatic brake structured to engage the stop block on the guide rail assembly until a desired operation is performed by the work piece processing equipment.

12. The system of claim 1, wherein the controller is further programmed to receive data associated with at least one dimension or attribute of a work piece to be processed by the work piece processing equipment and to adjust actuation or movement of the carriage assembly in response to the received data.

13. The system of claim 1, wherein the work piece processing equipment comprises a controller programmed for wireless communication with the controller of the carriage assembly, the mobile computing device, and at least one electronic measuring device.

14. The system of claim 13, wherein at least one of the controller of the work piece processing equipment or the controller of the carriage assembly is programmed for resisting actuation of the work piece processing equipment when an error condition is detected.

15. A work piece positioning system comprising:
a guide rail assembly structured for connection to an item of work piece processing equipment, the guide rail assembly comprising:
a series of guide rail segments modularly connectable together within the guide rail assembly,
at least one of the connectable guide rail segments having a measurement pattern positioned on a portion thereof; and
a carriage assembly structured for slidable engagement with at least a portion of the guide rail of the guide rail assembly, the carriage assembly comprising:
a controller configured for wireless data communication with at least one mobile computing device, and
a stop block.

16. The system of claim 15, wherein the series of guide rail segments is foldable to a length less than an overall length of the series of guide segments when extended.

17. The system of claim 15, wherein at least one of the series of guide rail segments is detachable or attachable to at least one of the other guide rail segments.

18. The system of claim 15, further comprising at least one work stand structured for mounting at least a portion of the guide rail assembly thereon.

19. A work piece positioning system comprising:
a guide rail assembly structured for connection to an item of work piece processing equipment, the guide rail assembly comprising:
at least one guide rail, and
a measurement pattern positioned on at least a portion of at least one guide rail; and
a carriage assembly structured for slidable engagement with at least a portion of the guide rail of the guide rail assembly, the carriage assembly comprising:
a controller configured for wireless data communication with at least one mobile computing device, and
a stop block.

20. The system of claim 19, wherein the controller is programmed to receive data communicated from an electronic measurement device.

21. The system of claim 19, wherein the controller is programmed to receive a cut-list including a list of cuts to be made on the work piece processing equipment.

22. The system of claim 19, wherein the controller is programmed to receive data derived from at least one information source associated with at least one dimension of a work piece or at least one attribute of a work piece environment.

23. The system of claim 19, wherein the controller is programmed to receive data associated with captured image data.

24. The system of claim 19, wherein the carriage assembly comprises at least one automatic brake structured to engage the stop block on the guide rail assembly until a desired operation is performed by the work piece processing equipment.

25. The system of claim 19, wherein the controller is further programmed to receive data associated with at least one dimension or attribute of a work piece to be processed by the work piece processing equipment and to adjust actuation or movement of the carriage assembly in response to the received data.

26. The system of claim 19, wherein the work piece processing equipment comprises a controller programmed for wireless communication with the controller of the carriage assembly, the mobile computing device, and at least one electronic measuring device.

27. The system of claim 26, wherein at least one of the controller of the work piece processing equipment or the controller of the carriage assembly is programmed for resisting actuation of the work piece processing equipment when an error condition is detected.
